(19) United States
(12) Patent Application Publication
(10) Pub. No.: US 2026/0249747 A1
(43) Pub. Date: Aug. 27, 2026

(54) ACTIVE POSTURE COMPENSATION SEAT AND ANTI-IMPACT ASSEMBLY THEREOF

(71) Applicant: GQY Dream Technology Group USA Ltd., Dover, DE (US)

(72) Inventors: Qiyin GUO, Zhejiang (CN); Jiangdong YANG, Zhejiang (CN); Nan HU, Zhejiang (CN); Lin SHEN, Zhejiang (CN)

(73) Assignee: GQY Dream Technology Group USA Ltd., Dover, DE (US)

(21) Appl. No.: 19/281,750

(22) Filed: Jul. 27, 2025

(30) Foreign Application Priority Data
Feb. 21, 2025 (CN) 202510195365.2
Feb. 26, 2025 (CN) 202510214155.3

(51) Int. Cl. B60N 2/02; B60N 2/427; B60N 3/06

(52) U.S. Cl. CPC B60N 2/0276; B60N 2/02246; B60N 2/42781; B60N 3/066

(57) ABSTRACT

An anti-impact assembly is configured to connect a seat body of a vehicle and includes a bottom plate, a pitch base plate, a motor connected to the bottom plate and the pitch base plate, and to drive the pitch base plate to move, a safety system electrically connected to the motor and includes a sensor and a controller. The controller adjusts the seat body to a first posture when the vehicle runs. In the first posture, a first pitch angle is formed between a bottom of the seat body and the bottom plate. The controller adjusts the seat body to a second posture when the vehicle is detected to be under emergency braking and/or collision risk. In the second posture, a second pitch angle is formed between the bottom of the seat body and the bottom plate. The first pitch angle is greater than the second pitch angle.

### CROSS-REFERENCE TO RELATED APPLICATION

This application claims the priority benefit of China application serial no. 202510195365.2, filed on Feb. 21, 2025 and China application serial no. 202510214155.3, filed on Feb. 26, 2025. The entirety of each of the above-mentioned patent applications is hereby incorporated by reference herein and made a part of this specification.

### BACKGROUND

### Technical Field

The present disclosure mainly relates to the technical field of seat, and specifically to an active posture compensation seat and its anti-impact assembly.

### Description of Related Art

Zero-gravity seat occupies an important position in the vehicle market due to its unique design concept and comfort. The zero-gravity seat simulates the zero-gravity environment in space by the precise mechanical structure to provide passengers with an ultimate relaxation experience. With the rapid development of the automotive industry, especially with the promotion of autonomous driving and intelligent safety system, the safety of seat has become a key area of concern. The traditional safety seat only relies on the airbag and the fixed structure to protect the passenger. However, in different traffic environments, traditional seat has relatively limited capabilities in pre-collision prediction and posture adjustment. Therefore, adopting more advanced technology to improve the response speed and accuracy of the seat has become the development direction of safety seat.

When passengers enjoy the comfort brought by the zero-gravity seat, there may be potential safety hazards. For example, when the vehicle is in a driving state and the seat is adjusted to the zero-gravity posture, in the event of a sudden collision, the traditional seat safety mechanism often does not adjust the seat back to the normal sitting position, thus increasing the risk of injury to passengers in the impact and collision.

When the vehicle is driving, road conditions such as potholes or speed bumps can also cause jolts. The current zero-gravity seat is not equipped with a footrest assembly, and usually the leg of passenger can only be placed in a curved shape, which is easy to cause fatigue when riding for a long time and reduces the comfort of the passenger. If a footrest assembly is installed that extends to the front of the seat, the overall size of the seat will increase dramatically, and requiring a large amount of space. This structure cannot be applied to environments with narrow space, such as compact car, small speedboat, ship, etc.

The current zero-gravity seat cannot guarantee the personal safety of passenger in the vehicle, and the riding comfort for passenger is poor, resulting in the problem of unsatisfactory passenger experience.

### SUMMARY

It would be advantageous to provide a mechanism for alleviating, mitigating, or eliminating at least one of the above problems.

In a first aspect, there is provided an anti-impact assembly, the anti-impact assembly being configured to connect to a seat body of a vehicle, the anti-impact assembly comprising: a bottom plate; a pitch base plate arranged opposite to the bottom plate; a motor respectively connected to the bottom plate and the pitch base plate, and the motor being configured to drive the pitch base plate to move; a radar system configured to detect a first data of the vehicle and an obstacle ahead, the first data comprising one or any combination of a relative velocity, a distance and an angle change; a vision system comprising a camera and a processor, the camera being configured to acquire a multi-dimensional space depth information of the vehicle, and the processor being configured to estimate a second data related to a collision with the obstacle ahead, the second data comprising a collision time and/or a collision angle; and a safety system electrically connected to the motor, the safety system comprising a sensor and a controller; and the controller being configured to adjust a posture of the seat body according to the first data, the second data and a data of the sensor; wherein: the controller being configured to drive the pitch base plate to move through the motor, thereby adjusting the seat body to a first posture when the vehicle runs normally, and in the first posture, a first pitch angle is formed between a bottom of the seat body and the bottom plate; the controller being configured to drive the pitch base plate to move through the motor, thereby adjusting the seat body from the first posture to a second posture when the vehicle is detected to be under emergency braking and/or there is a collision risk, and in the second posture, a second pitch angle is formed between the bottom of the seat body and the bottom plate, the first pitch angle is greater than the second pitch angle.

In a second aspect, there is provided an active posture compensation seat, comprising: a seat body being configured to support an object; an anti-impact assembly being configured to connect to the seat body, the anti-impact assembly comprising a bottom plate, a pitch base plate arranged opposite to the bottom plate, a motor respectively connected to the bottom plate and the pitch base plate, and the motor being configured to drive the pitch base plate to move; a seat footrest being coupled to the pitch base plate and being configured to support a foot of the object, wherein the seat footrest being configured to move with the pitch base plate to maintain a relative angle with the foot of the object.

It should be understood that the Summary is neither used to identify the key or essential features of the embodiments of the present disclosure, nor to limit the scope of the present disclosure. Other features of the present disclosure will become readily understood through the following description.

### BRIEF DESCRIPTION OF THE DRAWINGS

In order to make the above purposes, features and advantages of the present disclosure more apparent and understandable, the following detailed description of specific embodiments of the present disclosure is given in conjunction with the accompanying drawings, wherein:

FIG. 1 is a schematic diagram of the overall structure of the seat of an embodiment of the present disclosure;

FIG. 2 is a schematic diagram of the seat body in a first posture in an embodiment of the present disclosure;

FIG. 3 is a schematic diagram of the seat body in a second posture in an embodiment of the present disclosure;

FIG. 4 is a schematic diagram of the anti-impact assembly when the seat body is in a second posture in an embodiment of the present disclosure;

FIG. 5 is a side view of the anti-impact assembly when the seat body is in a second posture in an embodiment of the present disclosure;

FIG. 6 is a schematic diagram of the anti-impact assembly when the seat body is in a first posture in an embodiment of the present disclosure;

FIG. 7 is a side view of the anti-impact assembly when the seat body is in a first posture in an embodiment of the present disclosure;

FIG. 8 is a block diagram of a safety system in an embodiment of the present disclosure;

FIG. 9 is a flowchart showing the safety inspection process performed by the safety system on a vehicle in an embodiment of the present disclosure;

FIG. 10 is a curve diagram of a motion trajectory of the seat in an embodiment of the present disclosure.

FIG. 11 is a system block diagram of a safety system of another embodiment of the present disclosure;

FIG. 12 is a schematic diagram of the overall structure of the seat of another embodiment of the present disclosure;

FIG. 13 is a schematic diagram of the anti-impact assembly and the seat footrest when the seat body is in a first posture in an embodiment of the present disclosure;

FIG. 14 is a schematic diagram of the anti-impact assembly and the seat footrest when the seat body is in a second posture in an embodiment of the present disclosure;

FIG. 15 is a schematic diagram of the anti-impact assembly and the seat footrest in an embodiment of the present disclosure;

FIG. 16 is an exploded view of the anti-impact assembly and the seat footrest in an embodiment of the present disclosure;

FIG. 17 is a perspective view of the seat footrest of the present disclosure;

FIG. 18 is an exploded view of the seat footrest of the present disclosure;

FIG. 19 is a top view of the seat footrest of the present disclosure;

FIG. 20 is an exploded view of the folding pull rod driving mechanism in the seat footrest of the present disclosure;

FIG. 21 is a schematic diagram of the top view of the connecting rod assembly in the folded state touching the ground and bending freely when the seat footrest of the present disclosure is in roll anti-sway;

FIG. 22 is a front view of the connecting rod assembly in the folded state touching the ground and bending freely when the seat footrest of the present disclosure is in roll anti-sway;

FIG. 23 is a perspective view of the pedal assembly touching the ground and bending freely when the seat footrest of the present disclosure is in roll anti-sway;

FIG. 24 is a front view of the pedal assembly touching the ground and bending freely when the seat footrest of the present disclosure is in roll anti-sway;

FIG. 25 is a perspective view of the seat footrest of the present disclosure in an unlifted state;

FIG. 26 is a perspective view of the seat footrest of the present disclosure in a lifted state;

FIG. 27 is a perspective view of the seat footrest of the present disclosure in an intermediate extended posture;

FIG. 28 is a top view of the seat footrest of the present disclosure in an intermediate extended posture;

FIG. 29 is a perspective view of the seat footrest of the present disclosure in an extended position;

FIG. 30 is a top view of the seat footrest of the present disclosure in an extended position;

FIG. 31 is a perspective view of the seat footrest of the present disclosure in a stowed posture;

FIG. 32 is a top view of the seat footrest of the present disclosure in a stowed posture;

FIG. 33 is a schematic diagram showing the state of the footrest of the seat in an extended position in another embodiment of the present disclosure;

FIG. 34 is a schematic diagram showing the state of the footrest of the seat in a stowed posture in another embodiment of the present disclosure;

FIG. 35 is a schematic diagram showing the state of the footrest of the seat in a lifted posture in another embodiment of the present disclosure;

FIG. 36 is a schematic diagram showing the state of the pedal airbag of the footrest of the seat in an uninflated state in another embodiment of the present disclosure;

FIG. 37 is a schematic diagram showing the state of the pedal airbag of the footrest of the seat in an inflated state in another embodiment of the present disclosure.

### DESCRIPTION OF THE EMBODIMENTS

In order to make the above objects, features and advantages of the present disclosure more apparent and understandable, specific embodiments of the present disclosure are described in detail below in conjunction with the accompanying drawings.

The following description provides many specific details for the purpose of fully understanding the present disclosure, but the present disclosure may also be implemented in other ways different from those described herein, and therefore the present disclosure is not limited by the specific embodiments disclosed below.

As indicated in the present disclosure and in the claims, unless the context clearly indicates otherwise, words such as “a”, “an”, “one” and/or “the” do not specifically refer to the singular and may also include the plural. In general, the terms “include” and “comprise” suggest only the inclusion of clearly identified steps and elements, which do not constitute an exclusive list, and the method or device may also include other steps or elements.

Flowchart is used in the present disclosure to illustrate operations performed by a system according to the embodiment of the present disclosure. It should be understood that the preceding or following operations are not necessarily performed in an exact sequence. Instead, various steps may be processed in reverse order or simultaneously. Additionally, other operations are either added to these processes or one step or steps are removed from these processes.

The present disclosure provides an active posture compensation seat and its anti-impact assembly, the active posture compensation seat is equivalent to the zero-gravity seat, and in some embodiments described hereinafter, the terms “seat”, “active posture compensation seat”, and “zero-gravity seat” can be used interchangeably. During the operation of a vehicle (such as a car) in motion, the present disclosure can realize automatic adjustment of the posture of the seat to ensure that the passenger can quickly return to a relatively safe sitting position in an emergency, thereby effectively protecting the personal safety of passenger inside the vehicle. The seat is provided with a seat footrest, which can improve passenger riding comfort and prevent foot injuries. The present disclosure improves the passenger experience.

The technical solution of the present disclosure integrates the bottom plate, the pitch base plate, the motor, the radar system, the vision system, and the safety system, so that the anti-impact assembly is able to automatically adjust the seat body to a first posture with a larger pitch angle when the vehicle runs normally, so as to enhance the comfort of passenger; and when emergency braking or collision risk is detected, the seat body is quickly adjusted to a second posture with a smaller pitch angle, effectively reducing the impact on passenger caused by inertial forward movement and thereby improving the driving safety.

In some embodiments described hereinafter, the present disclosure provides the anti-collision function and the visual detection solution of the seat, which realize accurate collision prediction and seat posture adjustment by combining the radar system (such as the 4D millimeter wave radar) and the vision system (such as the binocular vision system with two cameras), as well as information on the vehicle speed, steering wheel rotation angle, etc. The present disclosure can accurately determine the collision timing in complex environments and proactively implement protective measures through the seat adjustment mechanism to safeguard passenger from injuries. The seat of the present disclosure is provided with the seat footrest, which employs two pairs of synchronous gears and connecting rods to form a folding mechanism, enabling extending and retracting movement with a large path length that allows the footrest to be hidden under the seat and adapt to narrow spaces. By setting the seat footrest into the extremely thin space beneath the seat, the passengers' foot can move with the seat, thereby enhancing riding comfort.

The active posture compensation seat of the present disclosure and its anti-impact assembly will be described in detail hereinafter.

The present disclosure provides an anti-impact assembly that is configured to connect to the seat body of the vehicle, the vehicle may be an automobile or a train, etc., and the present disclosure does not limit the type of vehicle. The technical solution of the present disclosure will be introduced by taking the vehicle seat as an example hereinafter. The anti-impact assembly of the present disclosure is provided with the safety system, the radar system and the vision system, wherein the safety system comprises the sensor and the controller, and the sensor may be referred to as a sensor module and the controller may be referred to as a control module. Exemplarily, each module in the safety system can be implemented by computer hardware devices consisting of a processor and a memory. Specifically, each of the above modules is stored as a program unit in the memory, and the processor executes each program unit stored in the memory to implement thread control.

The active posture compensation seat of the present disclosure is first described herein to facilitate understanding of the technical solution of the present disclosure. The seat of the present disclosure is equivalent to a zero-gravity seat, and the zero-gravity seat is capable of pitch adjustment. The zero-gravity seat can be provided at the rear of the vehicle, i.e., serving as a passenger seat. The anti-impact assembly of the present disclosure will be described hereinafter.

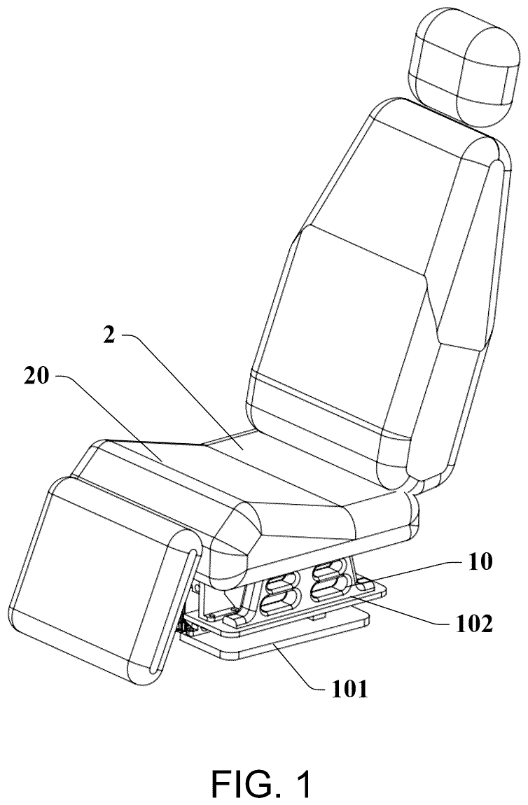

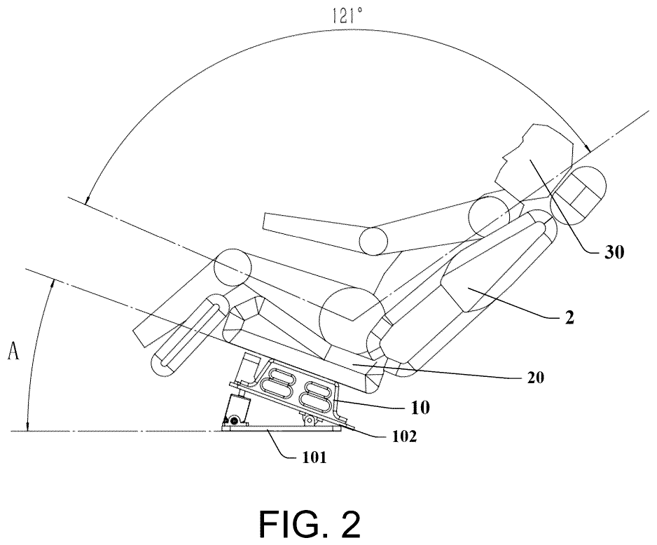

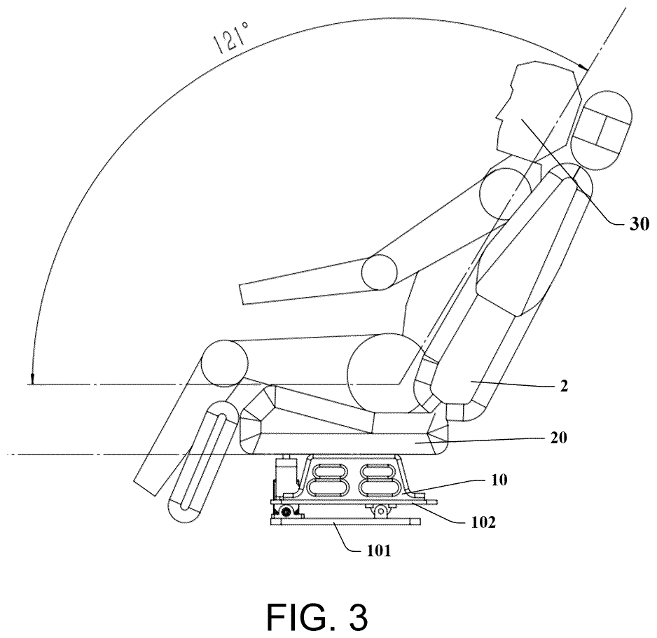

FIG. 1 is a schematic diagram of the overall structure of the seat of an embodiment of the present disclosure. FIG. 2 is a schematic diagram of the seat body in a first posture in an embodiment of the present disclosure. FIG. 3 is a schematic diagram of the seat body in a second posture in an embodiment of the present disclosure. Exemplarily, as shown in FIG. 1, the seat 2 of the present disclosure comprises the seat body 20 and the anti-impact assembly 10. As shown in FIGS. 2 and 3, the seat 2 is in a zero-gravity posture (e.g., 121°) when the passenger 30 is seated on the seat 2. As shown in FIG. 2, the passenger 30 is more comfortable when the seat body 20 is in a first posture. As shown in FIG. 3, in the event of emergencies such as sudden braking or collision of the vehicle, the anti-impact assembly 10 will quickly pull the seat body 20 back to the second posture (i.e., the normal seating posture), which can effectively reduce the impact that the passenger 30 receives due to inertial forward leaning, thereby ensuring the safety of the rear passenger 30.

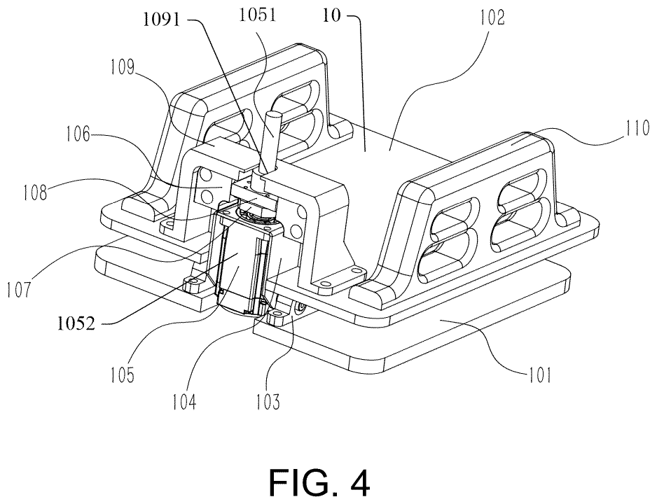

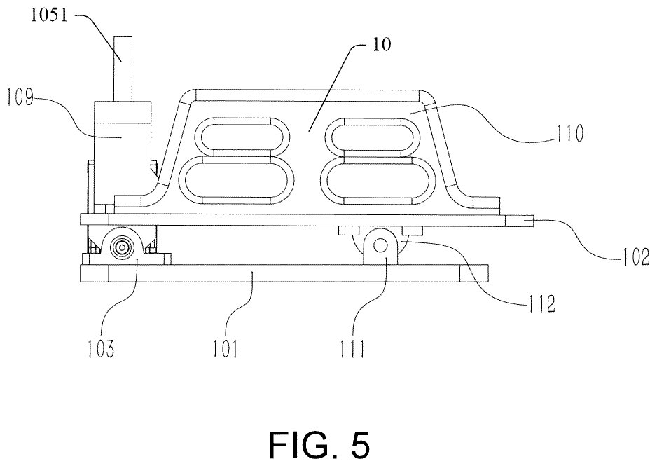

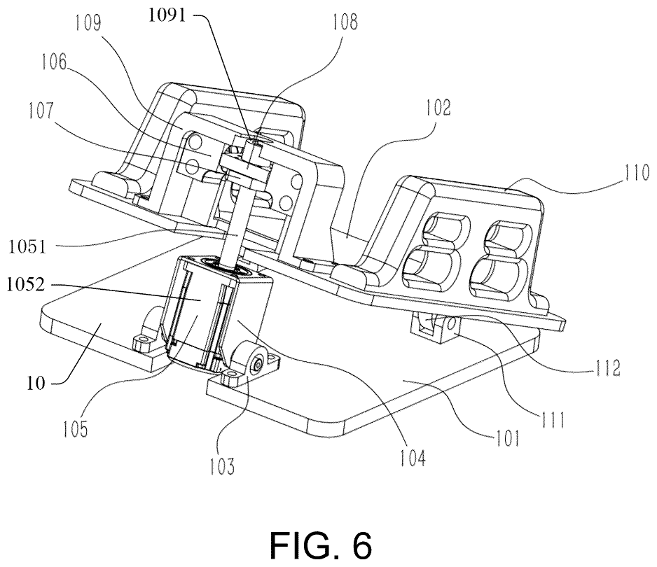

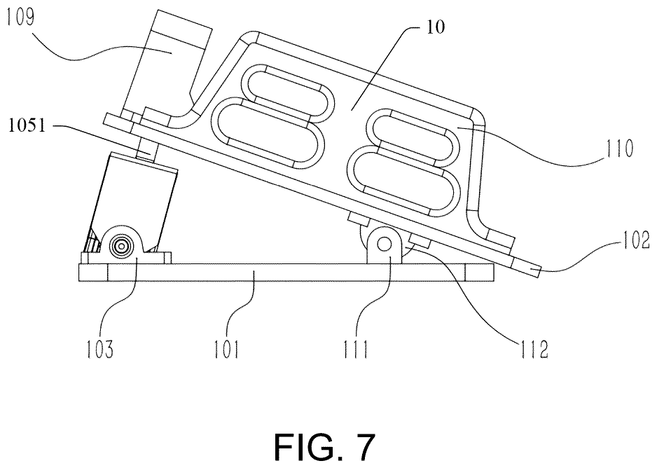

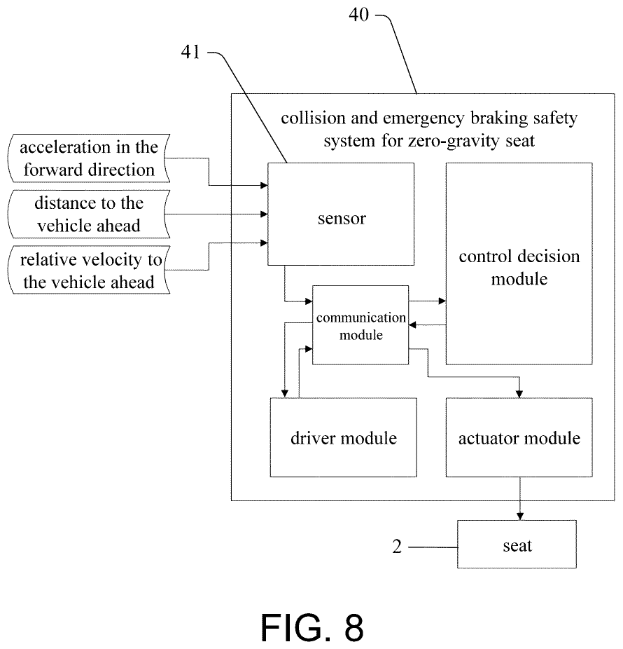

The anti-impact assembly 10 of the present disclosure will be described later. The anti-impact assembly 10 is equivalent to an anti-impact component of the seat. FIG. 4 is a schematic diagram of the anti-impact assembly when the seat body is in a second posture in an embodiment of the present disclosure. FIG. 5 is a side view of the anti-impact assembly when the seat body is in a second posture in an embodiment of the present disclosure. FIG. 6 is a schematic diagram of the anti-impact assembly when the seat body is in a first posture in an embodiment of the present disclosure. FIG. 7 is a side view of the anti-impact assembly when the seat body is in a first posture in an embodiment of the present disclosure. FIG. 8 is a block diagram of a safety system in an embodiment of the present disclosure.

Referring to FIGS. 4 to 8, the anti-impact assembly 10 of the present disclosure comprises: the bottom plate 101; the pitch base plate 102 arranged opposite to the bottom plate 101; a motor 105 respectively connected to the bottom plate 101 and the pitch base plate 102, and the motor 105 is configured to drive the pitch base plate 102 to move; the radar system (not shown in the figures) configured to detect the first data of the vehicle (i.e., the present vehicle) and the obstacle ahead, the first data comprising one or any combination of a relative velocity, a distance and an angle change; the vision system (not shown in the figures) comprises the camera and the processor, the camera is configured to acquire the multi-dimensional space depth information (e.g., three-dimensional space depth information) of the vehicle (i.e., the present vehicle), and the processor is configured to estimate the second data related to a collision with the obstacle ahead, the second data comprises the collision time and/or the collision angle; the safety system 40 electrically connected to the motor 105, the safety system 40 comprises the sensor 41 and the controller (not shown in the figures); and the controller is configured to adjust a posture of the seat body 20 according to the first data, the second data and the data of the sensor.

Exemplarily, referring to FIG. 8, the safety system 40 may be designed as the seat collision and braking safety system, and the controller includes the control decision module, the communication module, the drive module, and the actuator module.

Exemplarily, when the vehicle is running normally, the controller is configured to drive the pitch base plate 102 to move through the motor 105, thereby adjusting the seat body 20 to the first posture, at which time the anti-impact assembly 10 is in the state shown in FIG. 6; when the vehicle is detected to be under emergency braking and/or there is a collision risk, the controller is configured to drive the pitch base plate 102 to move through the motor 105, thereby adjusting the seat body 20 from the first posture to the second posture, while the anti-impact assembly 10 is in the state shown in FIG. 4. Referring to FIG. 2, it is shown that in the first posture: the first pitch angle A is formed between the bottom of the seat body 20 and the bottom plate 101; in the second posture: the second pitch angle (not shown in the figures) is formed between the bottom of the seat body 20 and the bottom plate 101; the first pitch angle A is greater than the second pitch angle.

The technical solution of the present disclosure integrates the bottom plate 101, the pitch base plate 102, the motor 105 and the safety system 40, so that the anti-impact assembly 10 is able to automatically adjust the seat body 20 to a first posture with a larger pitch angle when the vehicle runs normally, so as to enhance the comfort of the passenger 30; and when emergency braking or collision risk is detected, the seat body 20 is quickly adjusted to a second posture with a smaller second pitch angle, effectively reducing the impact on the passenger 30 caused by inertial forward movement and thereby improving the driving safety.

The present disclosure provides the anti-collision function and the visual detection solution of the seat, which realize accurate collision prediction and seat posture adjustment by combining the radar system (such as the 4D millimeter wave radar) and the vision system (such as the binocular vision system with two cameras), as well as information on the vehicle speed, steering wheel rotation angle, etc. The present disclosure can accurately determine the collision timing in complex environments and proactively implement protective measures through the seat adjustment mechanism to safeguard passengers from injuries.

In some embodiments, the first pitch angle A is between 10° and 25°, and the second pitch angle is greater than or equal to 0° and less than the first pitch angle A. Exemplarily, the first pitch angle A may be set to 10°, 15°, 20° and 25°, etc. The second pitch angle may be set to 0°, 1°, 2° and 5°, etc. By setting the first pitch angle A, the present disclosure ensures that the seat body 20 can provide sufficient recline angle to enhance the riding comfort of the passenger 30 when the vehicle runs normally. By setting the second pitch angle, the seat body 20 can be quickly adjusted to a more upright posture in emergency situations, effectively reducing the risk of the passenger 30 leaning forward due to a sudden vehicle deceleration or collision, and enhancing the safety of driving.

Referring to FIGS. 4 and 6, in some embodiments, the anti-impact assembly 10 further comprises the motor bracket 104, the motor 105 comprises the motor body 1052 and the shaft 1051, the bottom plate 101 is provided with the pitch shaft base 103, the motor bracket 104 is respectively connected to the motor body 1052 and the pitch shaft base 103. Exemplarily, the shape of the motor bracket 104 is adapted to the motor body 1052, which can serve to protect the motor. By providing the motor bracket 104 and the pitch shaft base 103, the present disclosure enhances the structural stability of the anti-impact assembly 10, and ensures the smoothness and reliability of the motor 105 when driving the movement of the pitch base plate 102.

Referring to FIG. 4, in some embodiments, the pitch base plate 102 is provided with the pitch mounting seat 109, the pitch mounting seat 109 is provided with the opening 1091, the opening 1091 is adapted to the shaft 1051, and one end of the shaft 1051 can pass through the opening 1091. Exemplarily, the opening 1091 has a limiting function on the shaft 1051, this configuration of the present disclosure ensures the stability and reliability of the seat body 20 during different posture adjustments.

Referring to FIGS. 4 and 6, in some embodiments, the motor 105 is the lead screw motor, the shaft 1051 is provided with external thread (not shown in the figures), the lead screw nut 107 and the nut mounting shaft 108 are sleeved on the shaft 1051, and the nut mounting shaft 108 is connected to the pitch mounting seat 109; when the shaft 1051 rotates in a forward direction or in a reverse direction, the lead screw nut 107 drives the nut mounting shaft 108 to make a co-directional linear motion. Exemplarily, when the shaft 1051 rotates, the lead screw nut 107 drives the nut mounting shaft 108, the pitch mounting seat 109, and the pitch base plate 102 to make a co-directional linear motion.

The present disclosure not only achieves precise adjustment of the posture of the seat body 20, but also improves post-adjustment stability through the self-locking characteristic of lead screw transmission, ensuring that the seat body 20 maintains the preset posture under different driving states of the vehicle, and providing a safer and more comfortable riding experience for the passenger 30.

Referring to FIG. 6, in some embodiments, the anti-impact assembly 10 further comprises the nut shaft bracket 106, the nut shaft bracket 106 is respectively connected to the pitch mounting seat 109 and the nut mounting shaft 108. Exemplarily, this configuration enhances the structural strength and stability of the entire transmission system, ensuring that the motor 105 maintains smooth operation during the movement of the pitch base plate 102.

Referring to FIGS. 2 and 6, in some embodiments, the pitch base plate 102 is provided with the seat mounting bracket 110, and one end of the seat mounting bracket 110 is connected to the bottom of the seat body 20. Exemplarily, this configuration achieves a firm connection between the seat body 20 and the pitch base plate 102.

Referring to FIGS. 5 and 7, in some embodiments, the bottom plate 101 is provided with the first pitch hinge 111, the pitch base plate 102 is provided with the second pitch hinge 112, the bottom plate 101 and the pitch base plate 102 are connected by the first pitch hinge 111 and the second pitch hinge 112. Exemplarily, the first pitch hinge 111 is equivalent to the lower pitch hinge, and the second pitch hinge 112 is equivalent to the upper pitch hinge. The first pitch hinge 111 and the second pitch hinge 112 are rotationally connected, this configuration of the present disclosure ensures that the pitch base plate 102, driven through the motor 105, enables the seat body 20 to achieve smooth and seamless posture adjustment.

Referring to FIGS. 2, 3, 4, and 6, an example is provided herein to illustrate the process of the seat body 20 changing from the 0° pitch angle to the 20° pitch angle (i.e., the first pitch angle A is) 20°. Exemplarily, when the lead screw motor operates, the lead screw nut 107 pushes the nut mounting shaft 108, the nut shaft bracket 106, and the pitch mounting seat 109, thereby pushing the pitch base plate 102 and the seat mounting bracket 110, ultimately causing the seat body 20 to assume the 20° pitch angle state. The present disclosure, by adopting the combination of the lead screw motor and the nut, enables quick control for the seat body 20 to return to the upright position (i.e., the seat body 20 is in the second posture) or revert to the comfortable zero-gravity state (i.e., the seat body 20 is in the first posture).

In some embodiments, the sensor 41 comprise the Inertial Measurement Unit (IMU) and the millimeter wave radar, and the sensor 41 is configured to collect one or any combination of the acceleration in the forward direction of the vehicle, the distance between the vehicle and other vehicles ahead, and the relative velocity between the vehicle and other vehicles ahead.

Referring to FIG. 8, exemplarily, the safety system 40 of the present disclosure can be configured to comprise five modules: the sensor 41, the communication module, the control decision module, the driver module, and the actuator module.
(1) The sensor 41 comprises the inertial measurement unit and the millimeter wave radar, which are used to collect the acceleration in the forward direction of the vehicle, the distance between the vehicle and other vehicles ahead, and the relative velocity between the vehicle and other vehicles ahead, respectively.
(2) The communication module is responsible for high-quality communication among other modules.
(3) The control decision module is the core module of the entire system. By analyzing data from the sensor, the control decision module can automatically plan the target trajectory of the seat so as to control the pitch of the seat.
(4) The driver module is used to drive the actuator module.
(5) The actuator module is the motor 105, which is used to execute control commands to realize the movement of the seat.

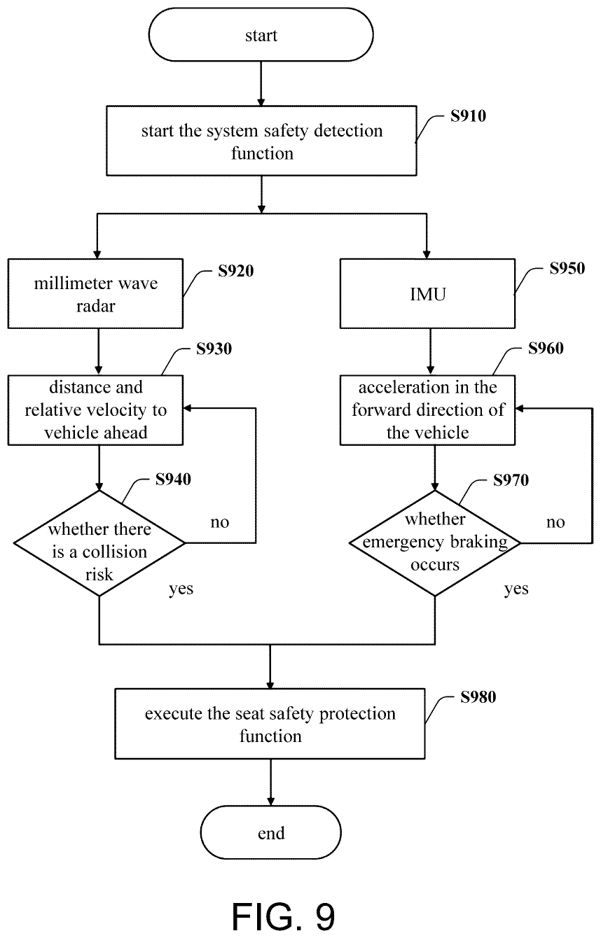

FIG. 9 is a flowchart showing the safety inspection process performed by the safety system on a vehicle in an embodiment of the present disclosure. Exemplarily, referring to FIG. 9, in step S910, start the system safety detection function; in step S920, activate the millimeter wave radar; in step S930, obtain the distance and the relative velocity between the vehicle and other vehicles ahead; in step S940, determine whether there is a collision risk, if the determination is negative, return to the step S930; if the determination is positive, proceed to the step S980; in step S950, activate the IMU; in step S960, acquire the acceleration in the forward direction of the vehicle; in step S970, determine whether emergency braking occurs, if the determination is negative, return to the step S960; if the determination is positive, proceed to the step S980; in step S980, execute the seat safety protection function.

The present disclosure can detect the distance and the relative velocity between the vehicle and other vehicles ahead in real time by the millimeter wave radar, thereby determining whether there is a collision risk; and it can determine whether the vehicle is in an emergency braking condition by the acceleration in the forward direction of the vehicle. When the vehicle is in any of the above-mentioned situations, the seat safety protection function is activated to adjust the seat angle to the zero position (corresponding to the second posture mentioned earlier), which can protect the safety of passenger.

Exemplarily, the present disclosure performs trajectory planning for adjusting the seat. Case 1: When the acceleration in the forward direction of the vehicle is less than a threshold value (the threshold value is generally taken as −0.7 g, i.e., 0.7 times the acceleration of gravity), the vehicle is in emergency braking. Case 2: When the minimum distance yₐ and the relative velocity v_{d} between the vehicle ahead and the traveling vehicle exceed the critical values, i.e., yₐ<yₛ and v_{d}>vₛ (the yₛ denotes minimum safe distance, the vₛ denotes relative safe velocity), the vehicle is at collision risk. This can be taken as yₛ=0.2 m and vₛ=0.3 m/s.

Exemplarily, when the vehicle is in any of the above-mentioned Case 1 and Case 2, the seat is instantaneously adjusted to the zero position to ensure the safety of passenger. Assuming the pitch angle of the seat is 20°, in order to ensure passenger safety, the seat needs to be adjusted from 20° to the zero position within the safety time tₛ. Considering the extreme case of collision, the present disclosure takes tₛ=120 ms, where ms denotes millisecond.

To ensure continuity during the starting process and the stopping process of the seat, an nth-degree polynomial can be used for trajectory planning. In some embodiments, the controller drives the pitch base plate to move through the motor, thereby adjusting the seat body from the first posture to the second posture, comprises the steps of:

Calculating the pitch angle between the bottom of the seat body and the bottom plate using the following nth-degree polynomial formula (1):

$${θ}_{n} ( t ) = {a}_{0} + {a}_{1} t + {a}_{2} {t}^{2} + … + {a}_{n} {t}^{n} \qquad ( 1 )$$

Wherein t denotes the time; θₙ(t) denotes the pitch angle corresponding to the time t, i.e., θₙ(t) is a function of angle with respect to time; and a₀, a₁, a₂ . . . aₙ denote the undetermined coefficients, the undetermined coefficients are related to the initial velocity of the movement of the pitch base plate, the final velocity of the movement of the pitch base plate, the acceleration of the movement of the pitch base plate, the first pitch angle and the second pitch angle;

Controlling the shaft of the motor to rotate according to the pitch angle θₙ(t). Exemplarily, the pitch angle corresponding to time t can be obtained according to θₙ(t), thereby controlling the rotation speed and the direction of the shaft.

In some embodiments, the controller drives the pitch base plate to move through the motor, thereby adjusting the seat body from the first posture to the second posture, comprises the steps of:

Calculating the pitch angle between the bottom of the seat body and the bottom plate using the following third-degree polynomial formula (2):

$$θ ( t ) = {a}_{0} + {a}_{1} t + {a}_{2} {t}^{2} + {a}_{3} {t}^{3} \qquad ( 2 )$$

Wherein t denotes the time; θ(t) denotes the pitch angle corresponding to the time t, i.e., θ(t) is a function of angle with respect to time; and a₀, a₁, a₂, a₃ denote the undetermined coefficients, the undetermined coefficients are related to the initial velocity of the movement of the pitch base plate, the final velocity of the movement of the pitch base plate, the first pitch angle and the second pitch angle;
Controlling the shaft of the motor to rotate according to the pitch angle θ(t).

Exemplarily, in the subsequent part of the present disclosure, the derivation of the formulas will take the time of 120 ms as an example.

To ensure continuity, the initial velocity and the final velocity can be set to 0, the initial angle is 20, and the final velocity is 0. The third-degree polynomial in formula (2) above-mentioned can be derived using the formula (3) to the formula (8) below, thereby calculating the values of the undetermined coefficients a₀, a₁, a₂, a₃.

Differentiating the formula (2) yields the formula (3) as follows:

$$\dot{θ} ( t ) = {a}_{1} + 2 {a}_{2} t + 3 {a}_{3} {t}^{2} \qquad ( 3 )$$

Considering the continuity, the initial velocity and the final velocity are 0, i.e., \dot{θ}(0)=0 and \dot{θ}(0.12)=0; the initial angle is 20 and the final angle is 0, i.e., θ(0)=20 and \dot{θ}(0.12)=0. This leads to the following system of formulas consisting of the formula (4) to the formula (7):

$$\dot{θ} ( 0 ) = {a}_{1} = 0 \qquad ( 4 )$$

$$\dot{θ} ( 0.12 ) = 2 {a}_{2} * 0.12 + 3 {a}_{3} * {( 0.12 )}^{2} = 0 \qquad ( 5 )$$

$$θ ( 0 ) = {a}_{0} = 20 \qquad ( 6 )$$

$$θ ( 0.12 ) = {a}_{1} * 0.12 + {a}_{2} * {( 0.12 )}^{2} + {a}_{3} * {( 0.12 )}^{3} = 0 \qquad ( 7 )$$

According to the system of equations composed of the formula (4) to the formula (7) above, the values of undetermined coefficients a₀, a₁, a₂, a₃ can be calculated, thereby obtaining the following formula (8):

$$θ ( t ) = 20 - 4166.68 {t}^{2} + 23148.15 {t}^{3} \qquad ( 8 )$$

Exemplarily, in practical applications, the following fifth-degree polynomial formula (9) can also be used to calculate the pitch angle between the bottom of the seat body and the base plate:

$$θ ( t ) = {a}_{0} + {a}_{1} t + {a}_{2} {t}^{2} + {a}_{3} {t}^{3} + {a}_{4} {t}^{4} + {a}_{5} {t}^{5} \qquad ( 9 )$$

When using the fifth-degree polynomial, the second differentiate of θ needs to be taken to obtain the formula (10) as follows:

$$\ddot{θ} ( t ) = 2 {a}_{2} + 6 {a}_{3} t \qquad ( 10 )$$

The initial velocity and the final velocity can be set to 0, and the system of equations can be constructed according to the method described earlier to solve for the values of a₀, a₁, a₂, a₃, a₄, a₅, which will not be repeated here.

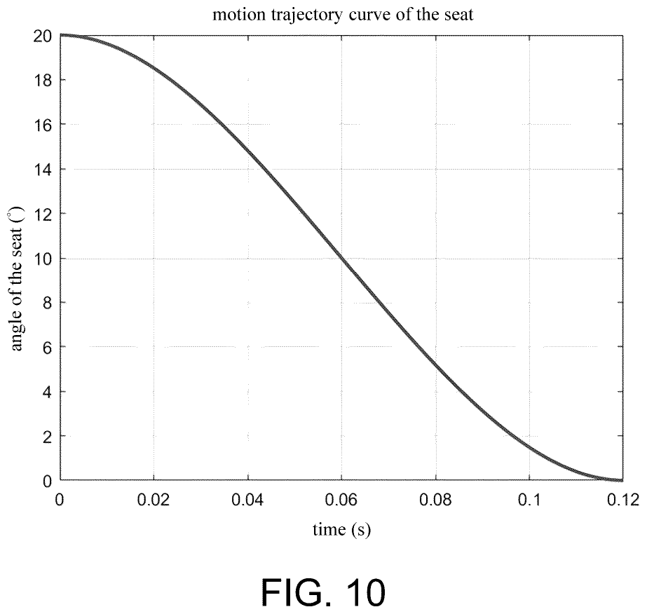

FIG. 10 is a curve diagram of a motion trajectory of the seat in an embodiment of the present disclosure. Referring to FIG. 10, exemplarily, in FIG. 10, the horizontal axis represents the time and the vertical axis represents the angle of the seat, and according to the motion trajectory curve, it can be seen that the seat will rapidly adjust from 20° to 0° in a time duration of 120 ms, which ensures the safety of the passenger in case of emergency situations such as emergency braking.

The present disclosure can plan the pitch angle of the seat to the corresponding motor movement by kinematic solution, and the motion control can adopt various control methods such as PID (Proportional Integral Derivative) control, optimal control, and MPC (Model Predictive Control) for controller design, which will not be repeated in the present disclosure.

In some embodiments, the anti-impact assembly 10 further comprises a master control system (not shown in the figures) that is configured to access the OBD (On-Board Diagnostics) interface of the vehicle, and obtain the driving velocity, the engine velocity, the steering wheel rotation angle of the vehicle (i.e., the present vehicle) in real time, as well as to determine whether there is an emergency braking and/or a collision risk.

Exemplarily, through the OBD interface of the vehicle, the present disclosure can obtain real-time information such as the driving velocity, the engine velocity, and the steering wheel rotation angle. In particular, the data on the steering wheel rotation angle can effectively prevent the anti-collision function from being accidentally triggered during vehicle turns. When the system detects that the vehicle is turning, it uses the algorithm to suppress potential false triggers and avoid misinterpreting dynamic changes caused by turning as collision threats.

In some embodiments, the radar system comprises the 4D millimeter wave radar; the vision system comprises a plurality of cameras and the processor, and the processor is further configured to identify and locate the obstacle ahead according to the image matching algorithm, the vision processing algorithm, and the first data. Exemplarily, the 4D millimeter wave radar detects the obstacle ahead of the vehicle by transmitting and receiving millimeter wave signals, and is capable of determining the relative velocity, the distance, and the angular change of the obstacle and the vehicle, so as to predict the time of collision occurrence in real time. The 4D millimeter wave radar features extremely high penetrability and precise distance measurement capabilities, enabling it to operate reliably in various complex environments, such as low-visibility conditions like rain, snow, and fog, etc.

The vision system of the present disclosure may adopt the binocular vision system, wherein the binocular camera can analyze the three-dimensional space depth information by acquiring image data from both left viewpoint and right viewpoint. The vision system of the present disclosure can accurately recognize and locate obstacles ahead and estimate the time and angle of collision by image matching algorithm and vision processing algorithm, combined with millimeter wave radar data.

In some embodiments, the controller adjusts the posture of the seat body according to the first data, the second data and the data of the sensor, comprises the steps of:

Calculating the relative velocity of the obstacle ahead using the following formula (11):

$$v\_rel = sqrt ( {( v\_obj - v\_car )}^{2} + {( v\_obj , y - v\_car , y )}^{2} ) \qquad ( 11 )$$

wherein v_rel denotes the relative velocity of the obstacle ahead; sqrt(·) denotes the square root function; v_obj denotes the velocity of the obstacle ahead; v_car denotes the velocity of the vehicle; v_obj,y denotes the longitudinal velocity component of the obstacle ahead; and v_car,y denotes the longitudinal velocity component of the vehicle;
Calculating the collision time using the following formula (12):

$$T\_collision = d\_obj / v\_rel \qquad ( 12 )$$

Wherein T_collision denotes the collision time; d_obj denotes the distance between the obstacle ahead and the vehicle;
Adjusting the seat body from the first posture to the second posture in response to the collision time is less than or equal to a preset time.

In some embodiments, the controller adjusts the posture of the seat body according to the first data, the second data and the data of the sensor, comprises the steps of:
In response to θ_threshold<|θ_turn-θ_target|, the controller does not adjust the posture of the seat body; wherein θ_threshold denotes the maximum threshold of the collision angle when the vehicle turns; θ_turn denotes the steering wheel angle of the vehicle; θ_target denotes the angle between the obstacle ahead and the forward direction of the vehicle; or
in response to v_car<v_threshold, the controller does not adjust the posture of the seat body; wherein v_car denotes the velocity of the vehicle; and v_threshold denotes the minimum vehicle speed threshold when the vehicle turns.

Exemplarily, the present disclosure avoids the accidental triggering of the seat adjustment mechanism during vehicle turns through the above-mentioned false trigger suppression algorithm. When the vehicle is turning, the influence of the steering wheel angle and vehicle dynamics can be used to determine whether the vehicle is in a safe state by the aforementioned method.

The present disclosure is equivalent to providing a seat anti-collision detection scheme combining the 4D millimeter wave radar and the binocular vision system. The present disclosure proposes the advanced seat anti-collision function and the precise detection method, which features high collision prediction accuracy. Through the rational algorithm, it suppresses false triggers to ensure passenger safety under complex driving conditions. The present disclosure can accurately predict vehicle collision timing in real time and adopt preventive measures by the seat adjustment mechanism to protect passenger from injury.

In some embodiments, the controller drives the pitch base plate 102 to move through the motor 105, thereby adjusting the seat body from the first posture to the second posture, comprising the steps of:

Adjusting the seat body from the first posture to the early warning posture in response to the collision time satisfying the relational equation: preset time≤collision time≤safety reservation time; and the early warning posture (not shown in the figures) is an intermediate posture between the first posture (shown in FIG. 2) and the second posture (shown in FIG. 3); and
obtaining the updated collision time in real time, and adjusting the seat body from the early warning posture to the second posture in response to the updated collision time satisfying the relationship equation: updated collision times preset time.

Exemplarily, the collision time can be calculated by the controller or estimated by the processor of the vision system, and the present disclosure is not limited. The preset time can be set to 1.5 seconds, and the preset time is used to indicate a threshold for a critical situation, for example, if the calculated collision time is 1 second, it means that the situation is critical with a high probability of collision, and the seat body 20 needs to be adjusted to the second posture (i.e., the collision prevention posture) immediately.

The safety reservation time can be set to 2.7 seconds. For example, if the calculated collision time is 2 seconds, it means that there is a low probability that a collision will occur or a collision will not occur, and at this time, the seat body 20 can first be adjusted from the first posture to the early warning posture at a preset speed or a slow speed, which increases the safety of the passenger, and avoids the discomfort caused by the rapid change of the posture of the seat, and improves the passenger's user experience. If the calculated collision time is 4 seconds, it means that a collision is unlikely to occur, equivalent to the warning is lifted, and the seat body 20 can be adjusted to the first posture (i.e., zero-gravity posture) at a slow speed to ensure the comfort of the passenger.

In some embodiments, the early warning posture corresponds to 60% to 80% of the movement path length of the pitch base plate 102. Exemplarily, the early warning posture can correspond to 60%, 65%, 70%, 75%, 80% of the movement path length of the pitch base plate. Referring to FIGS. 2, 3, 5, and 7, it is shown that when the pitch base plate 102 moves to different path lengths, it corresponds to different pitch postures of the seat body 20. Since the seat body 20 is adjusted to the early warning posture, the pitch base plate 102 still has a remaining movement path length of about 20% to 40%, even if a brief impact (such as emergency braking) may occur, it will not cause significant harm to the passenger, and can protect the passenger from the risk of being choked by the seat belt in the zero-gravity posture.

The present disclosure takes into account that the vehicle may jolt due to road factors such as potholed surfaces or speed bumps during driving, and therefore the seat footrest is designed to improve the comfort of the passenger when sitting on the seat.

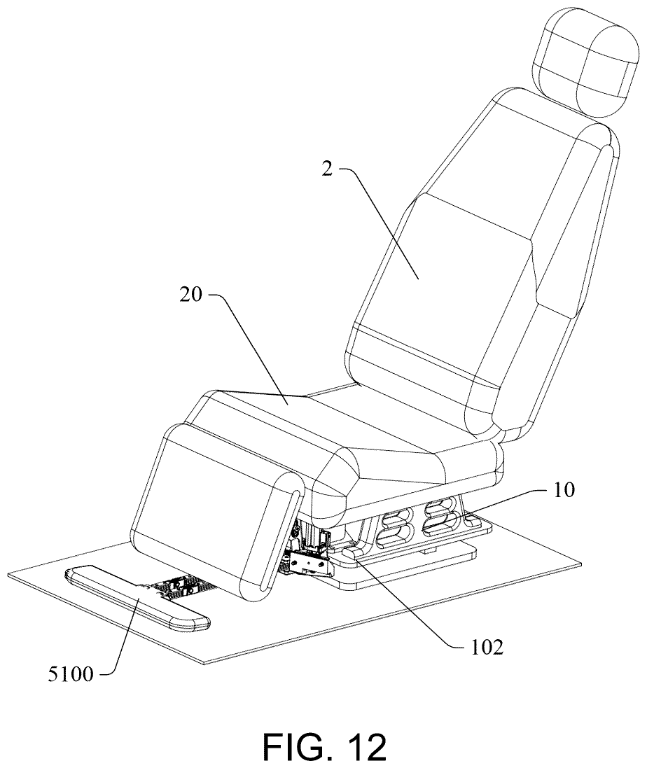

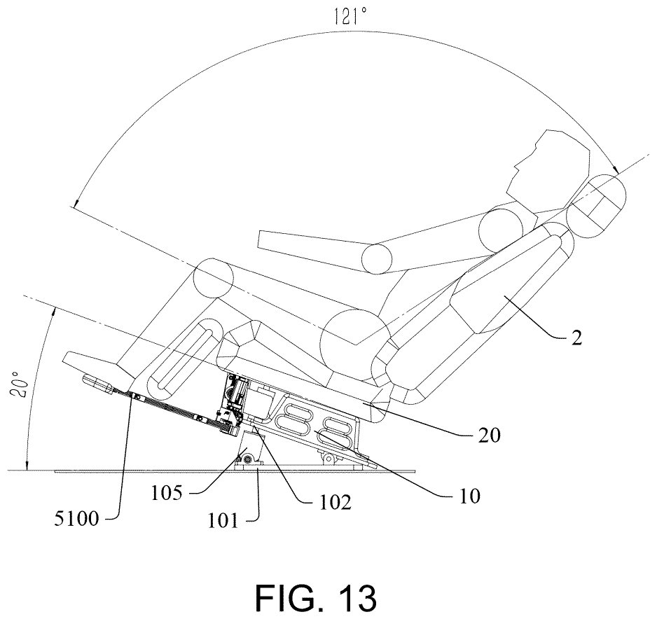

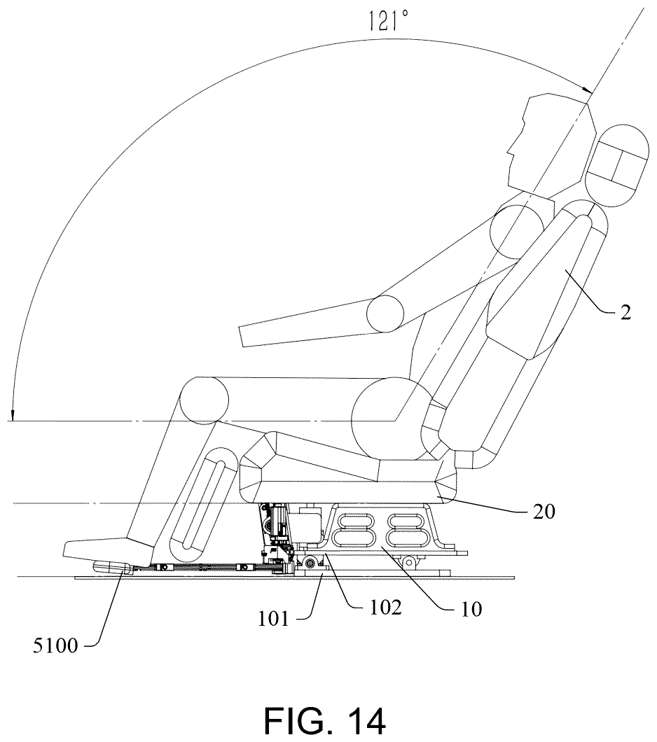

FIG. 12 is a schematic diagram of the overall structure of the seat of another embodiment of the present disclosure. FIG. 13 is a schematic diagram of the anti-impact assembly and the seat footrest when the seat body is in a first posture in an embodiment of the present disclosure. FIG. 14 is a schematic diagram of the anti-impact assembly and the seat footrest when the seat body is in a second posture in an embodiment of the present disclosure.

Referring to FIGS. 12 to 14, the present disclosure also proposes another seat 2 comprises: the seat body 20, which is configured to support the object; the anti-impact assembly 10, which is configured to connect to the seat body 20. The anti-impact assembly 10 comprises the bottom plate 101, the pitch base plate 102 arranged opposite to the bottom plate 101 and the motor 105 respectively connected to the bottom plate 101 and the pitch base plate 102, the motor 105 is configured to drive the pitch base plate 102 to move; the seat footrest 5100, which is coupled to the pitch base plate 102 and is configured to support the foot of the object, wherein the seat footrest 5100 is configured to move with the pitch base plate 102 to maintain a relative angle with the foot of the object.

Exemplarily, if the seat 2 is not provided with a footrest, the foot of the passenger will be in a suspended state, and in case of a hazardous situation such as emergency braking, when the seat 2 is rapidly changed from the first posture to the second posture, the foot of the passenger may touch the ground, which may result in injury to the foot. The seat footrest of the present disclosure can prevent passenger foot injuries by allowing passengers to rest their feet on the footrest after sitting on the seat, and avoiding direct foot contact with the ground.

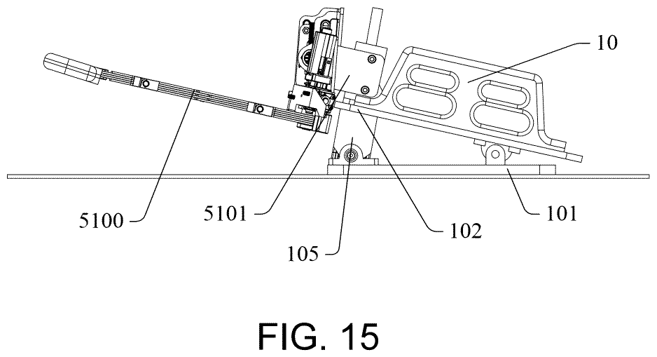

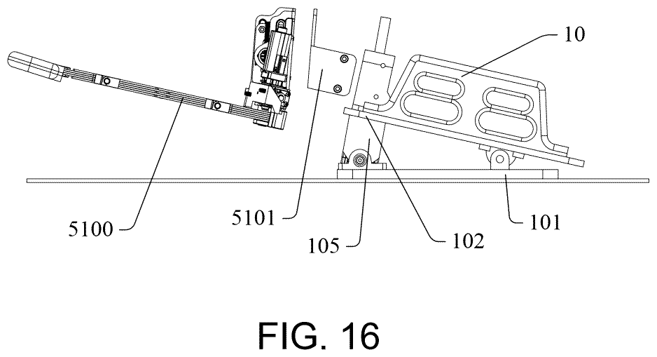

FIG. 15 is a schematic diagram of the anti-impact assembly and the seat footrest in an embodiment of the present disclosure. FIG. 16 is an exploded view of the anti-impact assembly and the seat footrest in an embodiment of the present disclosure. Referring to FIGS. 15 and 16, exemplarily, the seat footrest 5100 is coupled to the pitch base plate 102 by the connecting member 5101, the connecting member 5101 can be a connecting piece or a connecting panel. The connecting member 5101 can be coupled to the pitch mounting seat 109 on the anti-impact assembly 10 thereby enabling coupling to the pitch base plate 102.

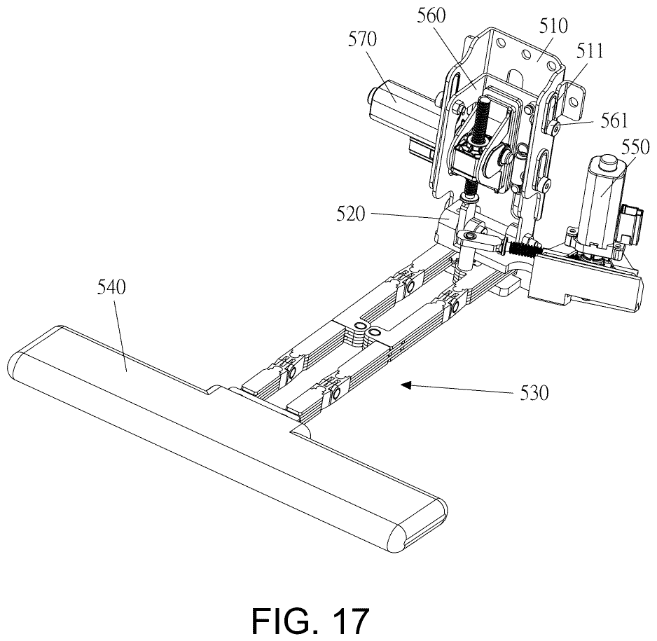

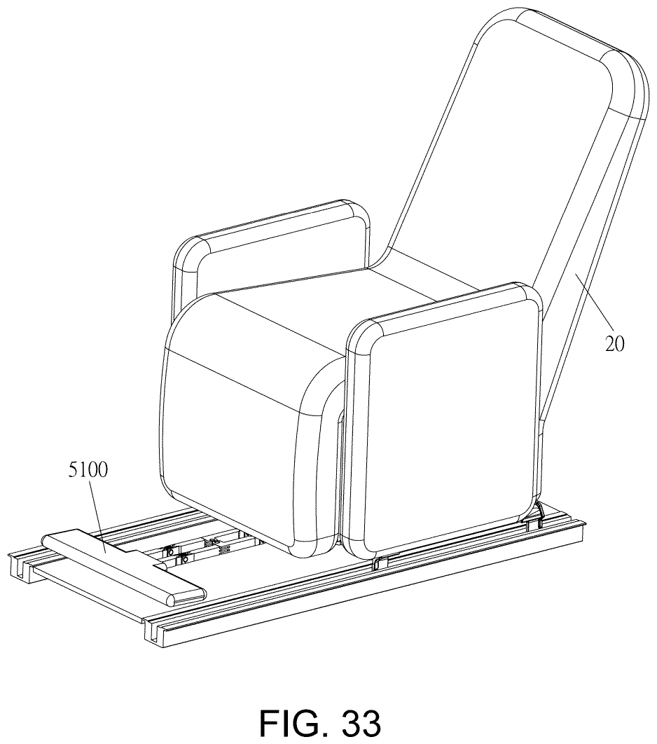

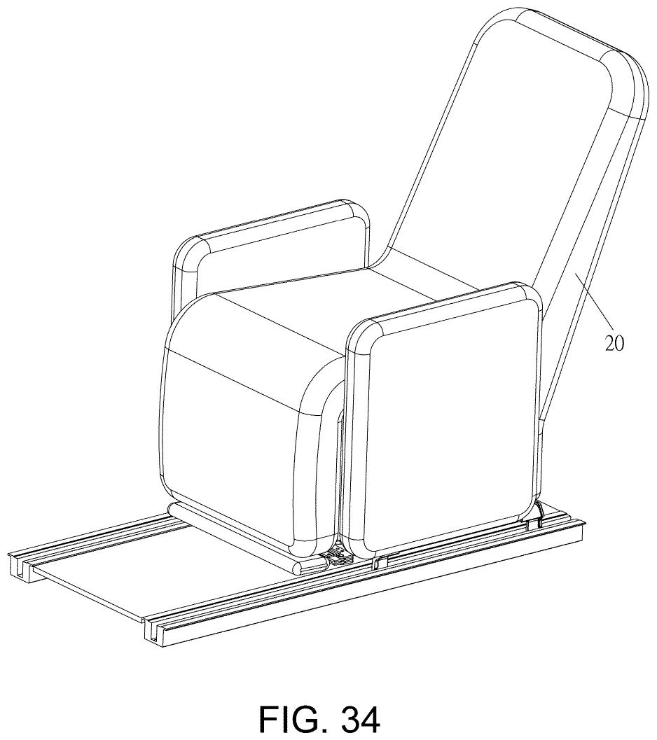

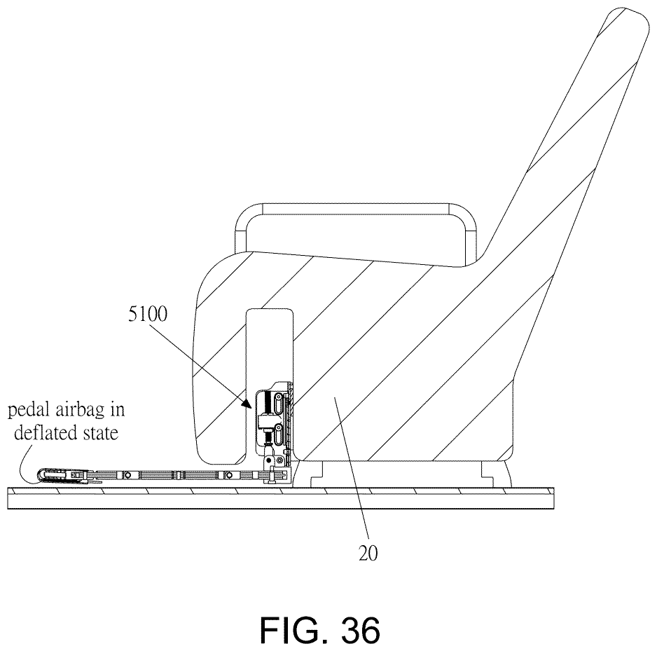

FIG. 17 is a perspective view of the seat footrest of the present disclosure. FIG. 33 is a schematic diagram showing the state of the footrest of the seat in an extended position in another embodiment of the present disclosure. FIG. 34 is a schematic diagram showing the state of the footrest of the seat in a stowed posture in another embodiment of the present disclosure. FIG. 36 is a schematic diagram showing the state of the pedal airbag of the footrest of the seat in an uninflated state in another embodiment of the present disclosure. The previously described anti-impact assembly is not shown in FIGS. 33 to 36.

Referring to FIGS. 13, 17, and FIGS. 33 to 36, the seat footrest 5100 of the present disclosure can be connected to the zero-gravity seat capable of pitching as previously described (as shown in FIG. 13), and can also be connected to a normal seat without pitching in FIG. 33.

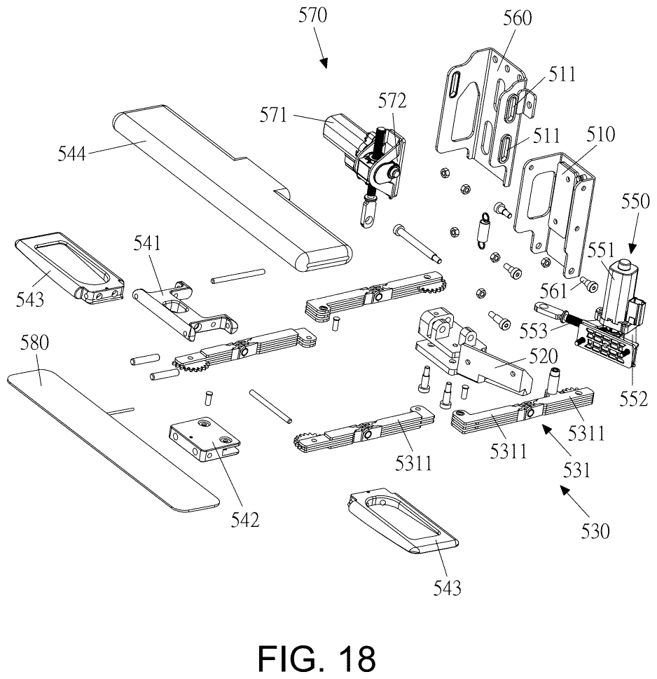

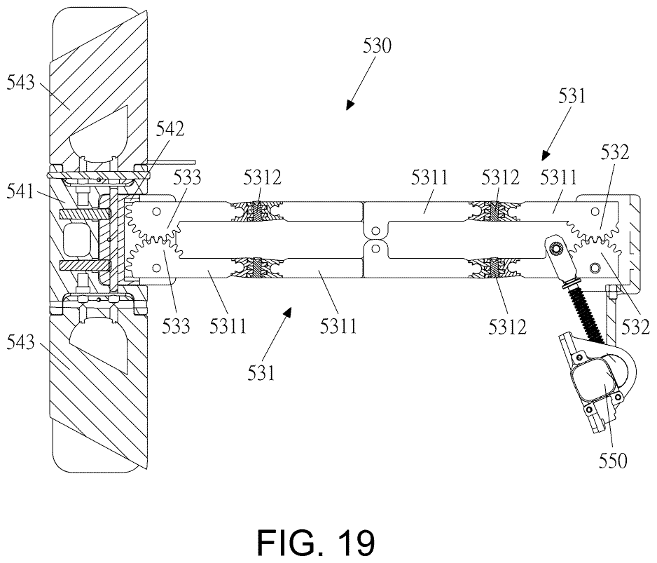

FIG. 18 is an exploded view of the seat footrest of the present disclosure. FIG. 19 is a top view of the seat footrest of the present disclosure. As shown in FIGS. 17 to 19, the present disclosure discloses a seat footrest 5100 comprises: the base 510, the connecting rod base 520, at least two sets of connecting rod assemblies 530 arranged parallel to each other, the pedal assembly 540, and the folding pull rod driving mechanism 550. Wherein the connecting rod base 520 is mounted to the lower end of the base 510. Each set of the connecting rod assemblies 530 comprise at least two connecting rods 531 rotatably connected to each other, the first ends of two sets of the connecting rod assemblies 530 are respectively fitted with the first synchronous gears 532 meshed with each other, and the first ends are rotatably connected to the connecting rod base 520.

The second ends of two sets of the connecting rod assemblies 530 are respectively fitted with the second synchronous gears 533 meshed with each other, and the second ends are rotatably connected to the pedal assembly 540. The folding pull rod driving mechanism 550 is mounted on the connecting rod base 520, and the driving part of the folding pull rod driving mechanism 550 is connected to one set of the connecting rod assemblies 530. The corresponding connecting rod assembly 530 is pulled by the folding pull rod driving mechanism 550, and the first synchronous gears 532 and the second synchronous gears 533 rotate to drive the connecting rod assemblies 530 to synchronously retract inwards or extend outwards.

By configuring the first synchronous gears 532 and the second synchronous gears 533 to be meshed, the present disclosure ensures that when the two sets of connecting rod assemblies 530 retract inwards or extend outwards, they achieve synchronous movement, remain in the same plane, and operate smoothly. The linkage arrangement of two pairs of synchronous gears enables the formed folding mechanism to realize the movement of extending and retracting with a large path length.

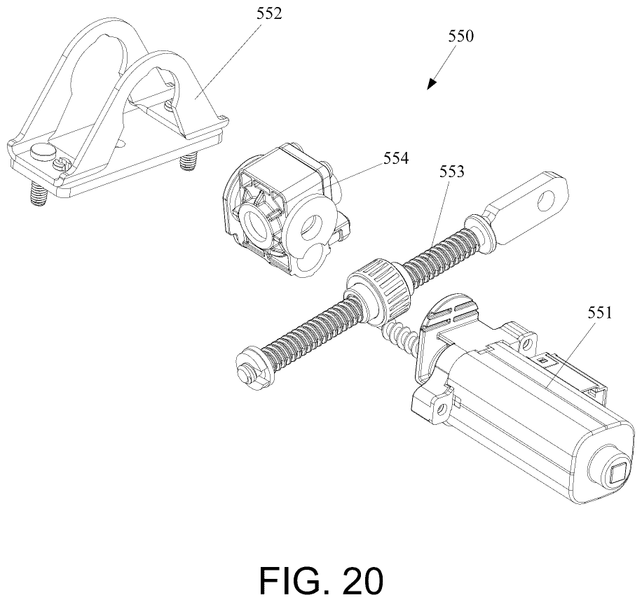

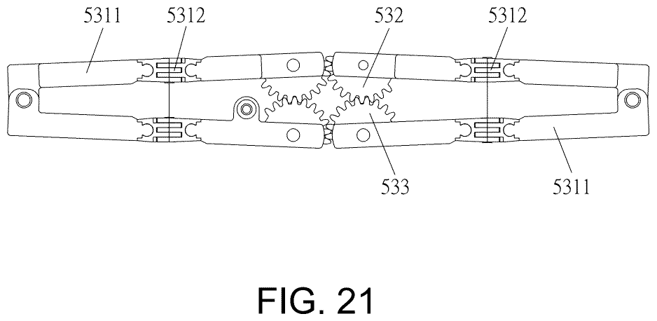

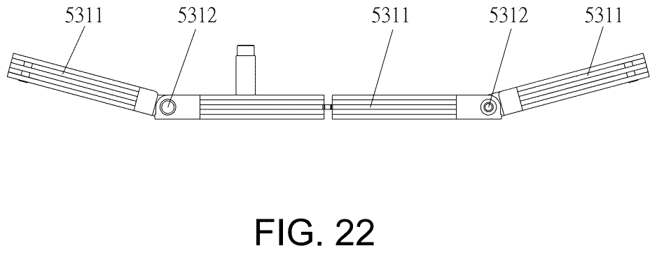

FIG. 20 is an exploded view of the folding pull rod driving mechanism in the seat footrest of the present disclosure. FIG. 21 is a schematic diagram of the top view of the connecting rod assembly in the folded state touching the ground and bending freely when the seat footrest of the present disclosure is in roll anti-sway. FIG. 22 is a front view of the connecting rod assembly in the folded state touching the ground and bending freely when the seat footrest of the present disclosure is in roll anti-sway.

Referring to FIGS. 20 to 22, in some embodiments, each connecting rod 531 comprises at least two connecting rod parts 5311 rotatably connected to each other. For example, the adjacent ends of two connecting rod parts 5311 are rotatably connected by the shaft 5312 (as shown in FIG. 19). Furthermore, the adjacent ends of two connecting rods 531 are also rotatably connected by a shaft. The present disclosure utilizes this rotational structure so that when the connecting rod assembly 530 is in the folded and retracted state and touches the ground, the connecting rod parts located on the outer side are bent upwardly relative to the connecting rod parts 5311 located on the inner side.

Exemplarily, as shown in FIG. 20, the folding pull rod driving mechanism 550 comprises the lead screw motor 551 and the motor mounting base 552, the lead screw motor 551 is mounted on the motor mounting base 552, the motor mounting base 552 is fixed to the connecting rod base 520, and the lead screw 553 of the lead screw motor 551 is connected to the corresponding connecting rod assembly 530. The lead screw motor 551 comprises the worm wheel 554 and the worm (i.e., the lead screw 553), which drives the lead screw 553 to pull or push the corresponding connecting rod assembly 530, thereby driving the first synchronous gear 532 and the second synchronous gear 533 to rotate, so as to enable the two sets of connecting rod assemblies 530 to retract inwards and extend outwards, thereby realizing the folding-retraction and extension functions of the footrest.

As shown in FIGS. 17 to 19, in some embodiments, the seat footrest in the present disclosure can further comprises the sliding base 560 and the stretching pull rod driving mechanism 570, the stretching pull rod driving mechanism 570 is mounted on the sliding base 560. At least one sliding groove 511 (e.g., two waist-shaped grooves at the top and bottom are provided in FIG. 18) is respectively formed on two side walls of the base 510. And at least one outward-protruding sliding member (e.g., pin 561) is mounted on the outer wall surfaces of two sides of the sliding base 560, the sliding member is mounted in the sliding groove 511. The driving part of the stretching pull rod driving mechanism 570 is connected to the connecting rod base to drive the sliding base 560 to move up and down along the base 510 by the sliding member, thereby driving the connecting rod base 520 to move up and down.

Referring to FIG. 18, exemplarily, the structure of the stretching pull rod driving mechanism 570 in this embodiment is consistent with the structure of the folding pull rod driving mechanism 550. The stretching pull rod driving mechanism 570 comprises the lead screw motor 571 and the motor mounting base 572, the lead screw motor 571 is mounted on the motor mounting base 572, the motor mounting base 572 is fixed to the sliding base 560, and the lead screw of the lead screw motor 571 is connected to the connecting rod base 520.

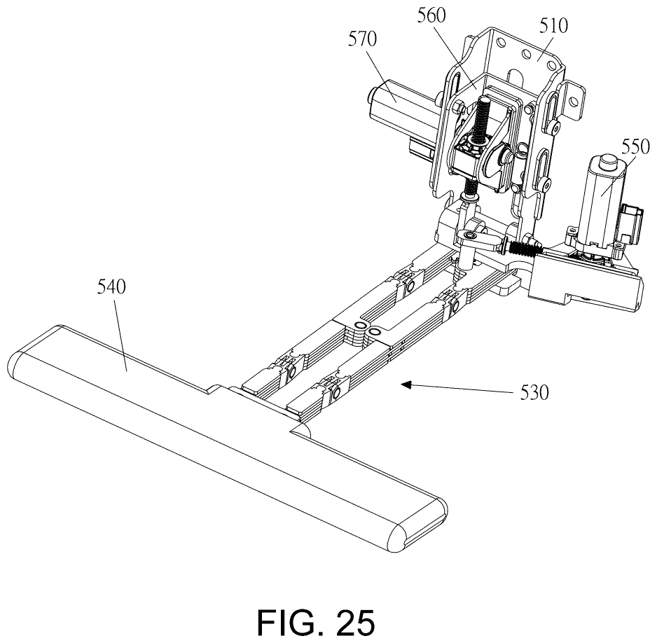

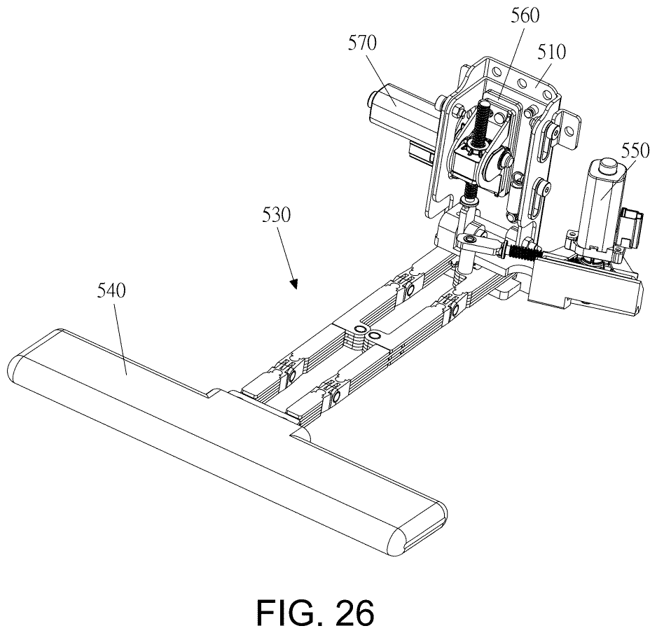

FIG. 25 is a perspective view of the seat footrest of the present disclosure in an unlifted state. FIG. 26 is a perspective view of the seat footrest of the present disclosure in a lifted state. Exemplarily, referring to FIGS. 25 and 26, the stretching pull rod driving mechanism 570 can realize the lifting action of the footrest, and the lead screw motor 571 drives the lead screw to pull the connecting rod base 520, causing the sliding base 560 to slide up and down along the two side walls of the base 510. Since the connecting rod base 520 and the base 510 are rotatably connected by the shaft, the connecting rod base 520 drives the connecting rod assembly 530 to lift upward together. This allows the entire footrest to be lifted at a certain angle.

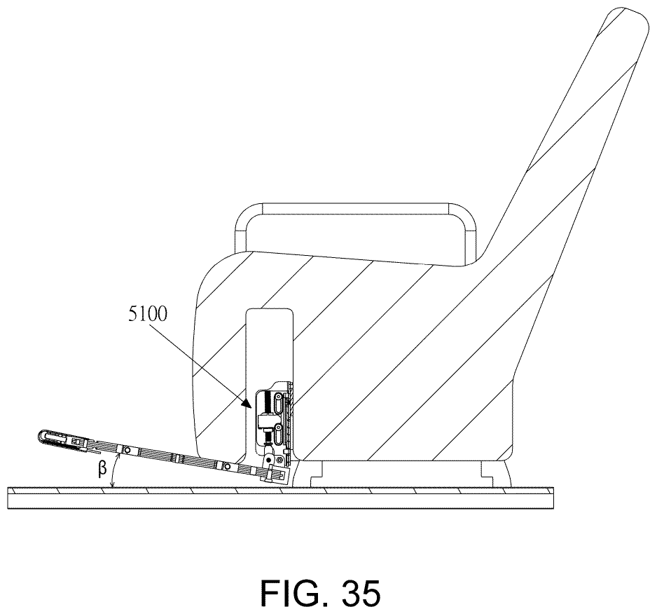

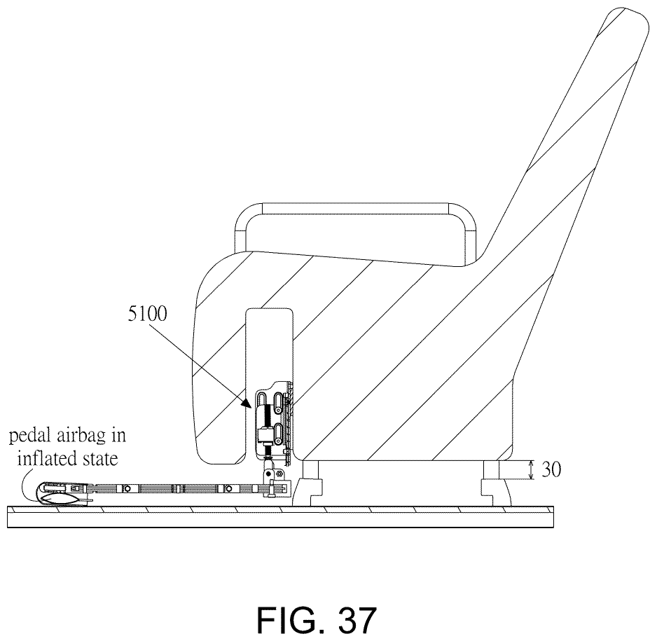

FIG. 35 is a schematic diagram showing the state of the footrest of the seat in a lifted posture in another embodiment of the present disclosure. FIG. 37 is a schematic diagram showing the state of the pedal airbag of the footrest of the seat in an inflated state in another embodiment of the present disclosure. Referring to FIGS. 35 and 37, the lifting action of the footrest can be realized by the lead screw motor 571 of the stretching pull rod driving mechanism 570 for adapting to the use of people of different heights. For example, when the anti-sway mechanism of the seat is operating, the entire footrest of the seat can be raised by a certain distance A, approximately 30 mm (as shown in FIG. 37). The connecting rod base 520 drives the connecting rod assembly 530 to lift upward at an angle β of approximately 10° (as shown in FIG. 35).

In some embodiments, as shown in FIG. 18, both the base 510 and the sliding base 560 are configured as open-type “concave” structures, for example, it is formed by bending a plate-like structure. The motor mounting base 572 is fixed inside the sliding base 560, and the lead screw motor 571 passes through the side portions of the base 510 and the sliding base 560 to be fixed to the motor mounting base 572.

Referring to FIGS. 17 and 18, in some embodiments, the pedal assembly 540 comprises the pedal base 541, the pedal connecting base 542, and two pedals 543. The pedal connecting base 542 is mounted on the pedal base 541, the pedal base 541 is rotatably connected to the second end of the connecting rod assembly 530 by the pedal connecting base 542, and the pedals 543 are rotatably connected to both sides of the pedal base 541.

As shown in FIG. 18, the pedal soft package 544 can also be wrapped around the exterior of the pedal assembly 540, which on the one hand can improve the aesthetics of the pedal assembly 540, and on the other hand can protect the pedal assembly 540 and slow down the impact on the pedal assembly 540.

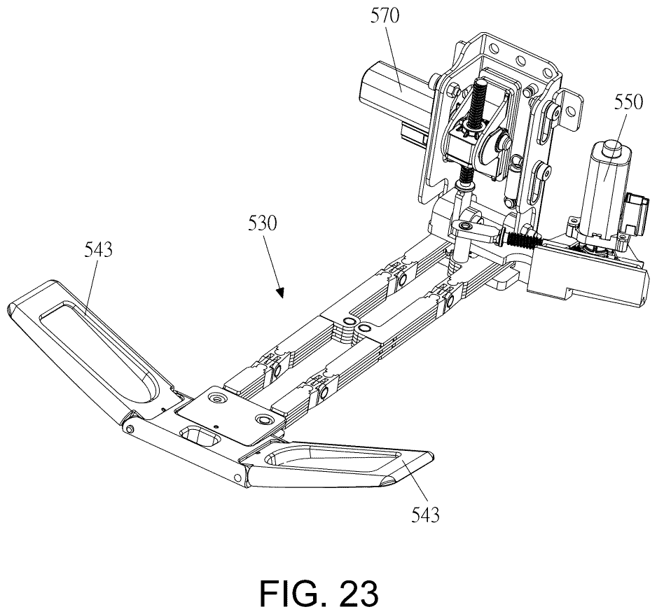

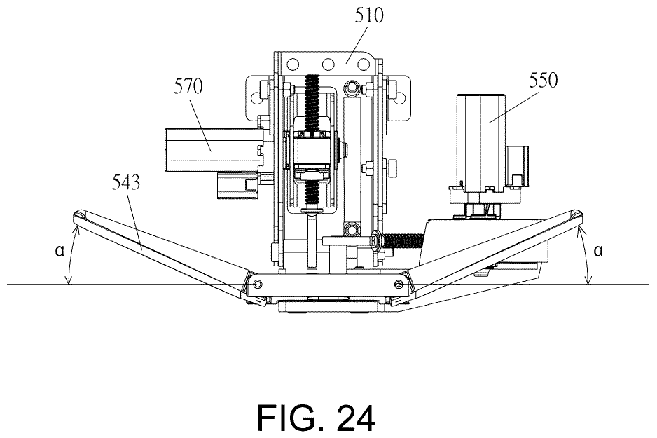

FIG. 23 is a perspective view of the pedal assembly touching the ground and bending freely when the seat footrest of the present disclosure is in roll anti-sway. FIG. 24 is a front view of the pedal assembly touching the ground and bending freely when the seat footrest of the present disclosure is in roll anti-sway.

As shown in FIGS. 23 and 24, the pedal 543 can be rotatably connected to two sides of the pedal base 541 by the shaft, and allowing the pedal 543 to touch the ground when the seat is rolled sideways. Once the pedal 543 touches the ground, the pedal 543 freely folds around the shaft and lifts upwardly, for example, the maximum allowable bend angle α is 20° (as shown in FIG. 24), thereby avoiding friction between the pedal 543 and the ground and reducing damage. Referring to FIGS. 18, 36, and 37, the seat footrest further comprises the pedal airbag 580, the pedal airbag 580 is mounted to the bottom of the pedal base 541. As shown in FIG. 36, when the pedal airbag 580 is not inflated, the seat footrest extends forward horizontally. As shown in FIG. 37, when the pedal airbag 580 is inflated, the pedal assembly 540 is pushed upwardly, causing the pedal assembly 540 to lift upwardly by a certain angle, further improving the comfort of the passenger.

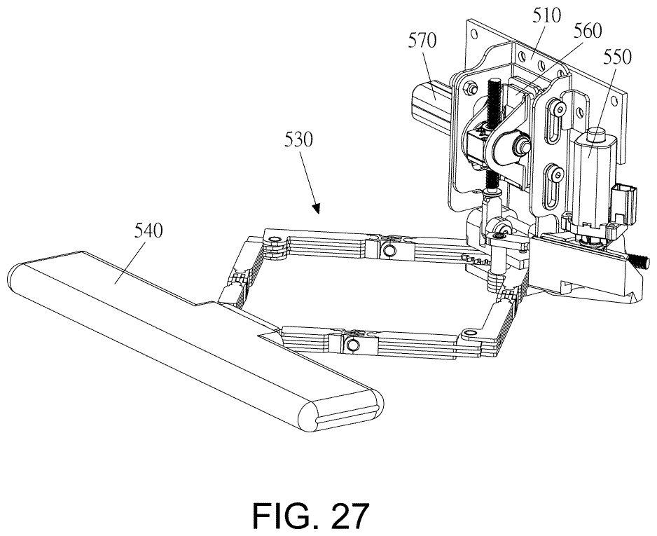

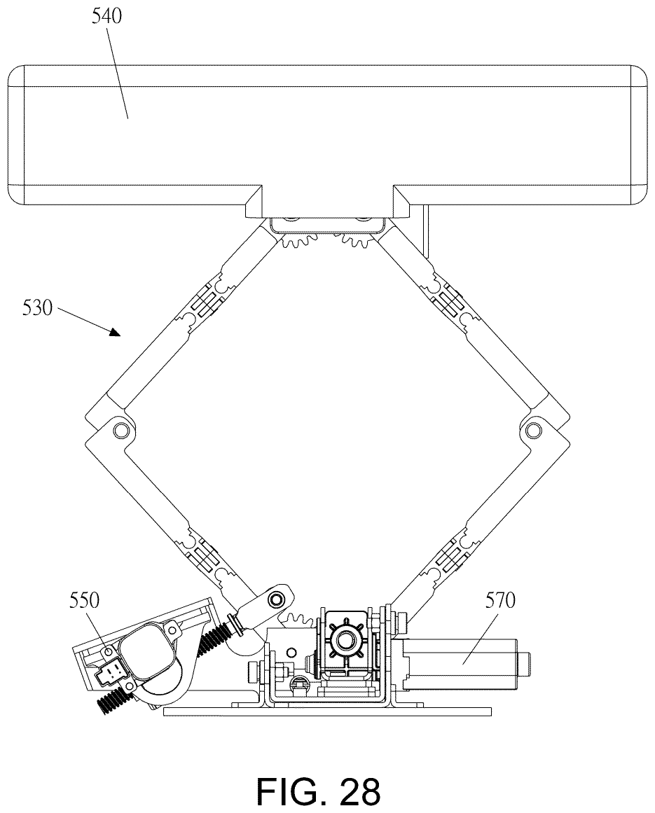

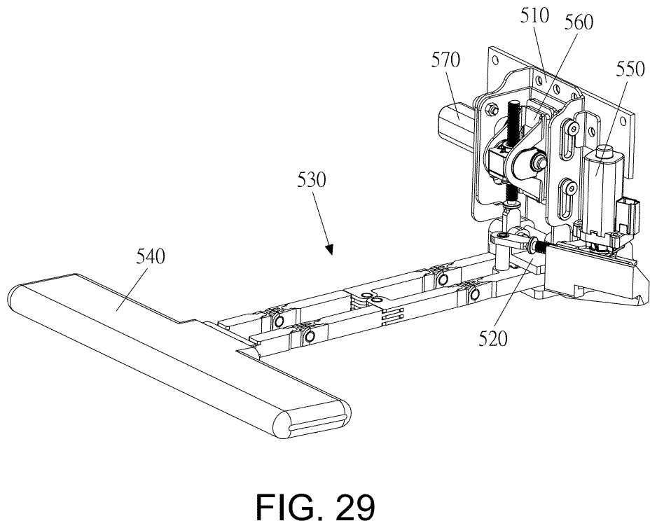

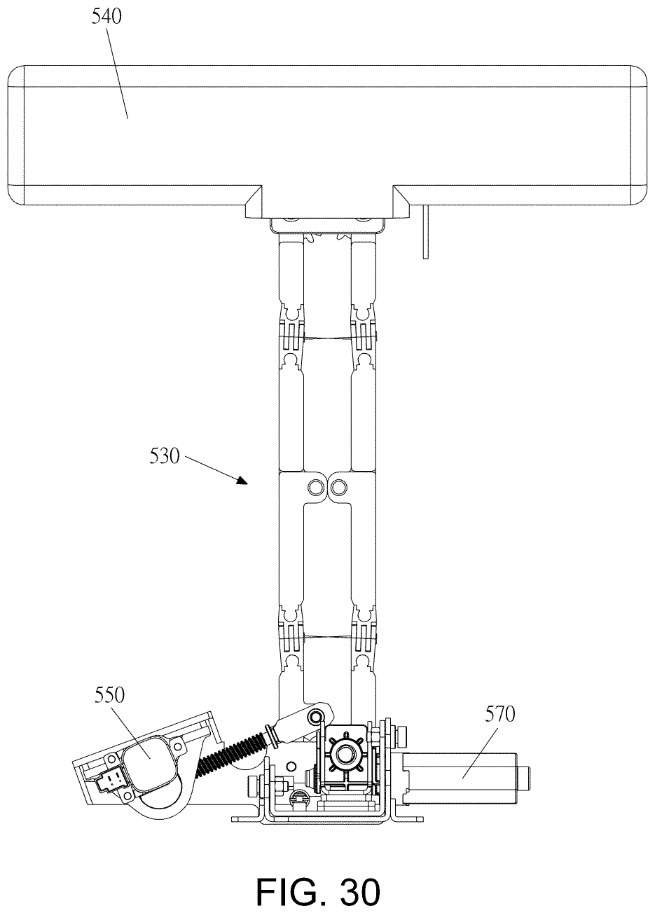

FIG. 27 is a perspective view of the seat footrest of the present disclosure in an intermediate extended posture. FIG. 28 is a top view of the seat footrest of the present disclosure in an intermediate extended posture. FIG. 29 is a perspective view of the seat footrest of the present disclosure in an extended position. FIG. 30 is a top view of the seat footrest of the present disclosure in an extended position.

As shown in FIGS. 27 and 28, when the seat footrest is required to be used, the folding pull rod driving mechanism 550 pushes the connecting rod assembly 530 in the folded state, and the first synchronous gear 532 and the second synchronous gear 533 begin to rotate, thereby driving the connecting rod assembly 530 to extend forward synchronously until it is fully deployed (as shown in FIGS. 29 and 30). At this time, the passenger can place foot on the footrest to enhance riding comfort.

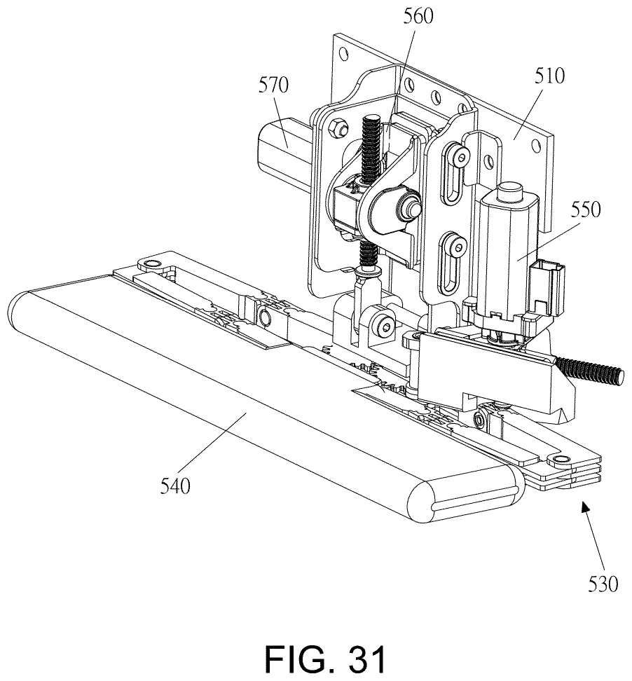

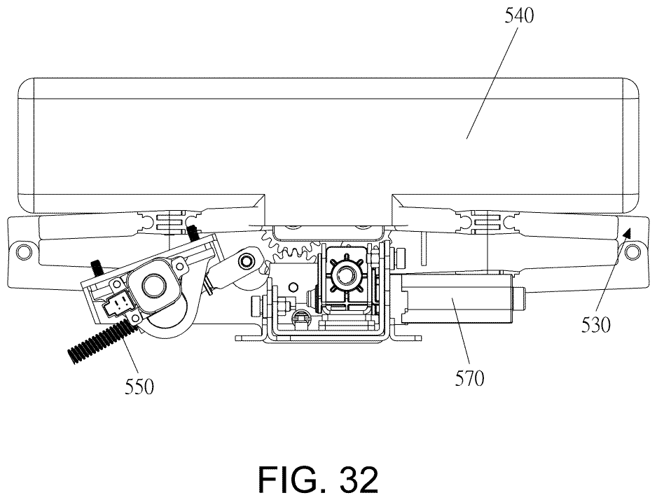

FIG. 31 is a perspective view of the seat footrest of the present disclosure in a stowed posture. FIG. 32 is a top view of the seat footrest of the present disclosure in a stowed posture.

Referring to FIGS. 31 and 32, when the seat footrest is not required to be used, the folding pull rod driving mechanism 550 pulls the connecting rod assembly 530 in the extended state, and the first synchronous gear 532 and the second synchronous gear 533 begin to rotate, thereby driving the connecting rod assembly 530 to fold and retract inward synchronously until fully folded (as shown in FIGS. 31 and 32). At this time, the seat footrest can be hidden to the bottom of the seat, adapting to various seat applications in narrow spaces and meeting the diverse seating needs of passengers.

As shown in FIGS. 33 to 37, the present disclosure also provides an anti-sway seat comprises the seat footrest 5100 as described above, and the base 510 of the seat footrest 5100 is fixed to the lower end of the anti-sway seat.

The active posture compensation seat and its anti-impact assembly of the present disclosure comprise the following advantages:
(1) Accurate prediction: Combining 4D millimeter wave radar, binocular vision system and vehicle speed, and steering wheel rotation angle data, it is able to accurately determine the timing of a collision in various complex environments and take anti-collision measures in advance.
(2) Anti false trigger: Through the accurate analysis of vehicle speed and steering wheel rotation angle information, it effectively avoids false triggering of collision alarm when turning.
(3) Multi environmental adaptability: The system can work reliably in low visibility conditions such as rain and fog, greatly enhancing safety.
(4) Adopting two pairs of synchronous gears and connecting rods to form the folding mechanism, realizing the movement of extending and retracting with a large path length, enabling the footrest to be hidden under the seat and adapting to narrow spaces.
(5) Adopting the lead screw motor to realize the lifting action of the footrest, matching the use of people of different heights.
(6) Utilizing the small thickness of the space under the seat, the foot of the passenger can follow the movement of the seat, making the ride more comfortable.
(7) The footrest of the seat can avoid injuries to the foot of the passenger, and the passenger can put foot on the footrest after sitting on the seat.

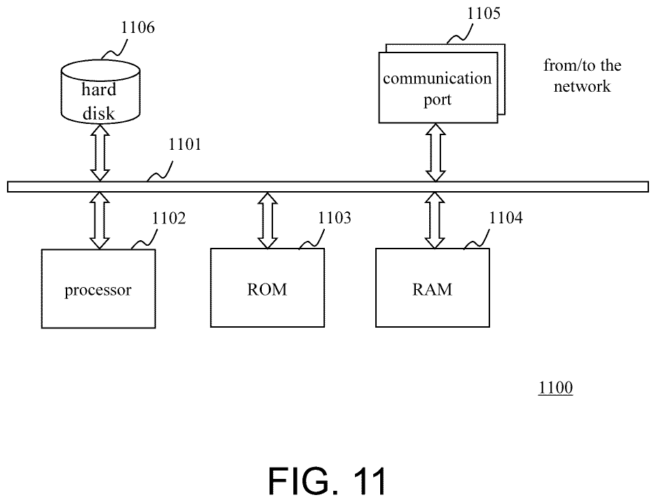

FIG. 11 is a system block diagram of a safety system of another embodiment of the present disclosure. Referring to FIG. 11, the safety system 1100 may include the internal communication bus 1101, the processor 1102, the read-only memory (ROM) 1103, the random-access memory (RAM) 1104, and the communication port 1105. The safety system 1100 may also include the hard disk 1106. The internal communication bus 1101 may enable inter-component data communication. The processor 1102 may make determinations and issue alerts. In some embodiments, the processor 1102 may comprise one or more processors. The communication port 1105 may enable data communication between this security system 1100 and external parties. In some embodiments, this security system 1100 may send and receive information and data from a network by the communication port 1105. This security system 1100 may also include different forms of program storage units to and data storage units, such as a hard disk 1106, read-only memory (ROM) 1103, and random-access memory (RAM) 1104, capable of storing various data files used by the computer for processing and/or communication, as well as possible program instructions executed by the processor 1102. The processor executes these instructions to implement major portions of the method. The results of the processor's processing are transmitted to the user device by a communication port for display on a user interface.

The method of adjusting the posture of the seat body as described earlier in the present disclosure may be implemented as a computer program, stored in the hard disk 1106, and may be loaded into the processor 1102 for execution.

The present disclosure also includes a computer readable medium storing computer program code that implements the method of adjusting the posture of the seat body as described previously when executed by the processor.

When the method for adjusting the posture of the seat body described in the present disclosure is implemented as a computer program, it may also be stored as an artifact in a computer-readable storage medium. For example, computer-readable storage media may include, but are not limited to, magnetic storage devices (e.g., hard disk, floppy disk, magnetic strip), optical disks (e.g., compact disc (CD), digital versatile disk (DVD)), smart cards, and flash memory devices (e.g., electrically erasable programmable read-only memory (EPROM), card, stick, and key driver). In addition, the various storage media described herein can represent one or more devices and/or other machine-readable media for storing information. The term “machine-readable medium” may include, but is not limited to, wireless channels and various other media (and/or storage media) capable of storing, containing and/or carrying code and/or instructions and/or data.

It should be understood that the embodiments described above are merely illustrative. The embodiments described herein may be implemented in hardware, software, firmware, middleware, microcode, or any combination thereof. For hardware implementations, the processor may be implemented within one or more application-specific integrated circuit (ASIC), digital signal processor (DSP), digital signal processing device (DSPD), programmable logic device (PLD), field-programmable gate array (FPGA), processor, controller, microcontroller, microprocessor, and/or other electronic unit designed to carry out the functions described herein or implemented within a combination thereof.

Some aspects of the present disclosure may be performed entirely by hardware, may be performed entirely by software (including firmware, resident software, microcode, etc.), or may be performed by a combination of hardware and software. Any of the above hardware or software may be referred to as a “block”, “module”, “engine”, “unit”, “component” or “system”. The processor may be one or more Application Specific Integrated Circuit (ASIC), Digital Signal Processor (DSP), Digital Signal Processor Device (DAPD), Programmable Logic Device (PLD), Field Programmable Gate Array (FPGA), processor, controller, microcontroller, microprocessor, or combinations thereof. Additionally, aspects of the present disclosure may be manifested as a computer product disposed in one or more computer-readable media that includes computer-readable program code. For example, computer-readable media may include, but are not limited to, magnetic storage devices (e.g., hard drive, floppy disk, magnetic tape . . . ), optical disks (e.g., zip disks CD, digital versatile disk DVD . . . ), smart cards, and flash memory devices (e.g., card, stick, key drive . . . ).

A computer-readable medium may contain a propagation data signal containing a computer program encoded within it, e.g., on a baseband or as part of a carrier. The propagation signal may have multiple manifestations, including electromagnetic, optical, etc., or suitable combinations thereof. The computer-readable medium may be any computer-readable medium other than a computer-readable storage medium that may be used to communicate, propagate, or transmit a program for use by connecting to an instruction execution system, device, or apparatus. The program code located on the computer-readable medium may be transmitted via any suitable medium, including radio, cable, fiber optic cable, radio frequency signal, or similar medium, or any combination of the foregoing.

### Aspects:

Aspect 1. A seat footrest, comprising:
   a base and a connecting rod base, the connecting rod base is mounted to a lower end of the base;
   at least two sets of connecting rod assemblies arranged parallel to each other, each set of the connecting rod assemblies comprising at least two connecting rods rotatably connected to each other, a first ends of two sets of the connecting rod assemblies are respectively fitted with a first synchronous gears meshed with each other, and the first ends are rotatably connected to the connecting rod base;
   a pedal assembly, a second ends of two sets of the connecting rod assemblies are respectively fitted with a second synchronous gears meshed with each other, and the second ends are rotatably connected to the pedal assembly;
   a folding pull rod driving mechanism, the folding pull rod driving mechanism is mounted on the connecting rod base, and a driving part of the folding pull rod driving mechanism is connected to one set of the connecting rod assemblies;
   the corresponding connecting rod assembly is pulled by the folding pull rod driving mechanism, and the first synchronous gears and the second synchronous gears rotate to drive the connecting rod assemblies to synchronously retract inwards or extend outwards.
Aspect 2. The seat footrest of aspect 1, wherein each connecting rod comprising at least two connecting rod parts rotatably connected to each other.
Aspect 3. The seat footrest of Aspect 2, wherein when the connecting rod assembly is in a folded and retracted state and touches the ground, the connecting rod parts located on an outer side are bent upwardly relative to the connecting rod parts located on an inner side.
Aspect 4. The seat footrest of aspect 1, wherein the folding pull rod driving mechanism comprises a lead screw motor and a motor mounting base, the lead screw motor is mounted on the motor mounting base, the motor mounting base is fixed to the connecting rod base, and a lead screw of the lead screw motor is connected to a corresponding connecting rod assembly.
Aspect 5. The seat footrest of aspect 1, further comprising a sliding base and a stretching pull rod driving mechanism, the stretching pull rod driving mechanism is mounted on the sliding base, at least one sliding groove is respectively formed on two side walls of the base, and at least one outward-protruding sliding member is mounted on outer wall surfaces of two sides of the sliding base, the sliding member is mounted in the sliding groove;
   the driving part of the stretching pull rod driving mechanism is connected to the connecting rod base to drive the sliding base to move up and down along the base by the sliding member, thereby driving the connecting rod base to move up and down.
Aspect 6. The seat footrest of aspect 5, wherein the stretching pull rod driving mechanism comprises a lead screw motor and a motor mounting base, the lead screw motor is mounted on the motor mounting base, the motor mounting base is fixed to the sliding base, and a lead screw of the lead screw motor is connected to the connecting rod base.
Aspect 7. The seat footrest of aspect 6, wherein both the base and the sliding base are configured as open-type “concave” structures, the motor mounting base is fixed inside the sliding base, and the lead screw motor passes through a side portion of the base and the sliding base to be fixed to the motor mounting base.
Aspect 8. The seat footrest of aspect 7, wherein the pedal assembly comprising a pedal base, a pedal connecting base, and two pedals, the pedal connecting base is mounted on the pedal base, the pedal base is rotatably connected to the second end of the connecting rod assembly by the pedal connecting base, and the pedals are rotatably connected to both sides of the pedal base.
Aspect 9. The seat footrest of aspect 8, further comprising a pedal airbag, the pedal airbag is mounted to a bottom of the pedal base.
Aspect 10. An anti-sway seat, comprising the seat footrest in any one of aspects 1-9, the base of the seat footrest is fixed to a lower end of the anti-sway seat.

Exemplarily, the seat footrest of the present disclosure can be referred to as a seat invisible footrest.

The basic concepts have been described above, and it will be apparent to those skilled in the art that the foregoing disclosure of the present disclosure is merely exemplary and does not constitute a limitation of the present disclosure. Although not expressly stated herein, those skilled in the art may make various modifications, improvements and amendments to the present disclosure. Such modifications, improvements, and amendments are suggested in the present disclosure, so such modifications, improvements, and amendments remain within the spirit and scope of the exemplary embodiments of the present disclosure.

At the same time, the present disclosure uses specific words to describe the embodiments of the present disclosure. For example, “one embodiment”, “an embodiment”, and/or “some embodiments” are meant to refer to a certain feature, structure, or characteristic associated with at least one embodiment of the present disclosure. Accordingly, it should be emphasized and noted that “an embodiment” or “one embodiment” or “an alternative embodiment” referred to twice or more at different locations in this specification does not necessarily refer to the same embodiment. In addition, certain features, structures, or characteristics in one or more embodiments of the present disclosure may be suitably combined.

Some embodiments use numbers to describe the number of components, attributes, and it should be understood that such numbers used in the description of the embodiments are modified in some examples by the modifiers “about”, “approximately”, or “substantially”. Unless otherwise noted, “about”, “approximately”, or “substantially” indicates that the numbers described allow for a variation of ±20%. Accordingly, in some embodiments, the numerical parameters used in the specification and claims are approximations, which may change depending on the desired characteristics of the individual embodiment. In some embodiments, the numerical parameters should take into account a specified number of valid digits and employ a general method of bit retention. Although the numerical domains and parameters used in some embodiments of the present disclosure to confirm the breadth of their ranges are approximations, in specific embodiments such values are set as precisely as practicable.

What is claimed is:

1. An anti-impact assembly, the anti-impact assembly being configured to connect to a seat body of a vehicle, the anti-impact assembly comprising:
a bottom plate;
a pitch base plate, arranged opposite to the bottom plate;
a motor, respectively connected to the bottom plate and the pitch base plate, and the motor being configured to drive the pitch base plate to move;
a radar system, configured to detect a first data of the vehicle and an obstacle ahead, the first data comprising one or any combination of a relative velocity, a distance and an angle change;
a vision system, comprising a camera and a processor, the camera being configured to acquire a multi-dimensional space depth information of the vehicle, and the processor being configured to estimate a second data related to a collision with the obstacle ahead, the second data comprising a collision time and/or a collision angle; and
a safety system, electrically connected to the motor, the safety system comprising a sensor and a controller; and the controller being configured to adjust a posture of the seat body according to the first data, the second data and a data of the sensor; wherein:
the controller is configured to drive the pitch base plate to move through the motor, thereby adjusting the seat body to a first posture when the vehicle runs normally, and in the first posture, a first pitch angle is formed between a bottom of the seat body and the bottom plate;
the controller is configured to drive the pitch base plate to move through the motor, thereby adjusting the seat body from the first posture to a second posture when the vehicle is detected to be under emergency braking and/or there is a collision risk, and in the second posture, a second pitch angle is formed between the bottom of the seat body and the bottom plate, the first pitch angle is greater than the second pitch angle.

2. The anti-impact assembly according to claim 1, further comprising a motor bracket, wherein the motor comprises a motor body and a shaft, the bottom plate is provided with a pitch shaft base, and the motor bracket is respectively connected to the motor body and the pitch shaft base.

3. The anti-impact assembly according to claim 2, wherein the pitch base plate is provided with a pitch mounting seat, the pitch mounting seat is provided with an opening, the opening is adapted to the shaft, and one end of the shaft can pass through the opening.

4. The anti-impact assembly according to claim 3, wherein the motor is a lead screw motor, the shaft is provided with an external thread, a lead screw nut and a nut mounting shaft are sleeved on the shaft, and the nut mounting shaft is connected to the pitch mounting seat; when the shaft rotates in a forward direction or in a reverse direction, the lead screw nut drives the nut mounting shaft to make a co-directional linear motion.

5. The anti-impact assembly according to claim 4, further comprising a nut shaft bracket, wherein the nut shaft bracket is respectively connected to the pitch mounting seat and the nut mounting shaft.

6. The anti-impact assembly according to claim 1, wherein the bottom plate is provided with a first pitch hinge, the pitch base plate is provided with a second pitch hinge, and the bottom plate and the pitch base plate are connected by the first pitch hinge and the second pitch hinge.

7. The anti-impact assembly according to claim 1, wherein driving the pitch base plate to move through the motor, thereby adjusting the seat body from the first posture to the second posture, comprising the steps of:
calculating a pitch angle between the bottom of the seat body and the bottom plate using the following nth-degree polynomial formula:
$${θ}_{n} ( t ) = {a}_{0} + {a}_{1} t + {a}_{2} {t}^{2} + … + {a}_{n} {t}^{n}$$
wherein t denotes a time; θₙ(t) denotes a pitch angle corresponding to the time t; a₀, a₁, a₂ . . . aₙ denote undetermined coefficients, the undetermined coefficients are related to an initial velocity of a movement of the pitch base plate, an final velocity of a movement of the pitch base plate, an acceleration of a movement of the pitch base plate, the first pitch angle and the second pitch angle; and
controlling a shaft of the motor to rotate according to the pitch angle θₙ(t).

8. The anti-impact assembly according to claim 1, wherein driving the pitch base plate to move through the motor, thereby adjusting the seat body from the first posture to the second posture, comprising the steps of:
calculating a pitch angle between the bottom of the seat body and the bottom plate using the following third-degree polynomial formula:
$$θ ( t ) = {a}_{0} + {a}_{1} t + {a}_{2} {t}^{2} + {a}_{3} {t}^{3}$$
wherein t denotes a time; θ(t) denotes a pitch angle corresponding to the time t; a₀, a₁, a₂, a₃ denote undetermined coefficients, the undetermined coefficients are related to an initial velocity of a movement of the pitch base plate, a final velocity of a movement of the pitch base plate, the first pitch angle and the second pitch angle; and
controlling a shaft of the motor to rotate according to the pitch angle θₙ(t).

9. The anti-impact assembly according to claim 1, wherein the first pitch angle is between 10° and 25°, and the second pitch angle is greater than or equal to 0° and less than the first pitch angle.

10. The anti-impact assembly according to claim 1, wherein the sensor comprises an inertial measurement unit and a millimeter wave radar, the sensor is configured to collect one or any combination of an acceleration in a forward direction of the vehicle, a distance between the vehicle and other vehicles ahead, and a relative velocity between the vehicle and other vehicles ahead.

11. The anti-impact assembly according to claim 1, further comprising a master control system configured to access an OBD interface of the vehicle, and obtain a driving velocity and/or a steering wheel rotation angle of the vehicle in real time, as well as to determine whether there is an emergency braking and/or a collision risk.

12. The anti-impact assembly according to claim 1, wherein the radar system comprises a 4D millimeter wave radar; the processor is further configured to identify and locate the obstacle ahead according to an image matching algorithm, a vision processing algorithm, and the first data.

13. The anti-impact assembly according to claim 1, wherein adjusting the posture of the seat body according to the first data, the second data and the data of the sensor, comprises the steps of:
calculating a relative velocity of the obstacle ahead using the following formula:
$$v\_rel = sqrt ( {( v\_obj - v\_car )}^{2} + {( v\_obj , y - v\_car , y )}^{2} )$$
wherein v_rel denotes a relative velocity of the obstacle ahead; sqrt(·) denotes a square root function; v_obj denotes a velocity of the obstacle ahead; v_car denotes a velocity of the vehicle; v_obj,y denotes a longitudinal velocity component of the obstacle ahead; and v_car,y denotes a longitudinal velocity component of the vehicle;
calculating a collision time using the following formula:
$$T\_collision = d\_obj / v\_rel$$
wherein T_collision denotes the collision time; d_obj denotes a distance between the obstacle ahead and the vehicle;
adjusting the seat body from the first posture to the second posture in response to the collision time is less than or equal to a preset time.

14. The anti-impact assembly according to claim 1, wherein adjusting the posture of the seat body according to the first data, the second data and the data of the sensor, comprises the steps of:
not adjusting the posture of the seat body in response to θ_threshold<|θ_turn−θ_target|;
wherein θ_threshold denotes a maximum threshold of a collision angle when the vehicle turns; θ_turn denotes a steering wheel angle of the vehicle; θ_target denotes an angle between the obstacle ahead and a forward direction of the vehicle; or
not adjusting the posture of the seat body in response to v_car<v_threshold; wherein v_car denotes a velocity of the vehicle; and v_threshold denotes a minimum vehicle speed threshold when the vehicle turns.

15. The anti-impact assembly according to claim 1, wherein adjusting the seat body from the first posture to the second posture, comprises the steps of:
adjusting the seat body from the first posture to an early warning posture in response to the collision time satisfying a relational equation: preset time≤collision time≤safety reservation time; and the early warning posture is an intermediate posture between the first posture and the second posture; and
obtaining an updated collision time in real time, and adjusting the seat body from the early warning posture to the second posture in response to the updated collision time satisfying a relationship equation: updated collision times preset time.

16. The anti-impact assembly according to claim 15, wherein the early warning posture corresponds to 60%-80% of a movement path length of the pitch base plate.

17. An active posture compensation seat, comprising:
a seat body, being configured to support an object;
an anti-impact assembly, being configured to connect to the seat body, the anti-impact assembly comprising a bottom plate, a pitch base plate arranged opposite to the bottom plate, a motor respectively connected to the bottom plate and the pitch base plate, and the motor being configured to drive the pitch base plate to move;
a seat footrest, being coupled to the pitch base plate and being configured to support a foot of the object, wherein the seat footrest is configured to move with the pitch base plate to maintain a relative angle with the foot of the object.

18. The active posture compensation seat according to claim 17, wherein the seat footrest comprising:
a base and a connecting rod base, wherein the connecting rod base is mounted to a lower end of the base;
at least two sets of connecting rod assemblies, arranged parallel to each other, each set of the connecting rod assemblies comprising at least two connecting rods rotatably connected to each other, a first ends of two sets of the connecting rod assemblies are respectively fitted with a first synchronous gears meshed with each other, and the first ends are rotatably connected to the connecting rod base;
a pedal assembly, a second ends of two sets of the connecting rod assemblies are respectively fitted with a second synchronous gears meshed with each other, and the second ends are rotatably connected to the pedal assembly;
a folding pull rod driving mechanism, mounted on the connecting rod base, wherein a driving part of the folding pull rod driving mechanism is connected to one set of the connecting rod assemblies;
wherein the corresponding connecting rod assembly is pulled by the folding pull rod driving mechanism, and the first synchronous gears and the second synchronous gears rotate to drive the connecting rod assemblies to synchronously retract inwards or extend outwards.

19. The active posture compensation seat according to claim 18, wherein each connecting rod comprises at least two connecting rod parts rotatably connected to each other; when the connecting rod assembly is in a folded and retracted state and touches the ground, the connecting rod parts located on an outer side are bent upwardly relative to the connecting rod parts located on an inner side.

20. The active posture compensation seat according to claim 18, wherein the pedal assembly comprises a pedal base, a pedal connecting base, and two pedals, the pedal connecting base is mounted on the pedal base, the pedal base is rotatably connected to the second end of the connecting rod assembly by the pedal connecting base, and the pedals are rotatably connected to both sides of the pedal base.
